(19) United States
(12) Patent Application Publication
(10) Pub. No.: US 2022/0399571 A1
(43) Pub. Date: Dec. 15, 2022

(54) PROCESSES FOR MAKING BATTERIES COMPRISING POLYMER MATRIX ELECTROLYTES

(71) Applicant: BRIGHTVOLT, INC., Redmond, WA (US)

(72) Inventors: Joykumar Thokchom, Marietta, GA (US); Anaba Anani, Bloomington, IN (US)

(21) Appl. No.: 17/344,025

(22) Filed: Jun. 10, 2021

(51) Int. Cl. H01M 10/0565; H01M 4/38; H01M 10/058; H01M 4/525; H01M 4/505; H01M 4/587

(52) U.S. Cl. CPC H01M 10/0565; H01M 4/382; H01M 10/058; H01M 4/525; H01M 4/505; H01M 4/587; H01M 2300/008; H01M 2300/0082

(57) ABSTRACT

Provided herein is a high-volume continuous roll-to-roll method for manufacturing dimensionally stable, large format, high performance solid batteries using high lithium-ion conducting polymer matrix electrolyte (PME). The batteries can include a cathode layer sandwich with a thin contiguous PME layer across the anode and a high conducting PME in both the anode and cathode structures. The batteries can also retain a thin PME layer that functions as solid-state electrolyte between the cathode and anode thus maintaining continuity among the layers, resulting in minimal interface resistance and stronger structural integrity.

### TECHNICAL FIELD

The invention relates generally to safe energy storage devices and in particular, solid-state lithium-ion batteries using high conducting semi-solid and/or solid-state polymer matrix electrolytes (PMEs) and methods of manufacturing the same.

### BACKGROUND

Solid batteries with high energy density are the most sought-after energy storage devices for portable devices, heavy duty drones, unmanned aerial vehicles, and automobile applications as they are much safer compared to the conventional state-of-the-art lithium-ion batteries, LiBs. Safety problems in LiBs arise mainly from the utilization of highly volatile and flammable organic solvents and chemically unstable lithium salt which associate with leakage and undergo exothermic reactions under certain operational and abuse conditions, eventually leading to catastrophic thermal runaway and explosion. Furthermore, LiBs are susceptible to lithium dendrite formation due to the presence of liquid electrolytes under conditions of uneven current distributions, especially at high charge-discharge rates. This eventually causes cell shorting and thermal runaway which are of safety concerns, due to the inability of the porous separator to suppress lithium dendrites formed. Furthermore, LiBs have a limited operating temperature range due to liquid electrolyte's decomposition at high temperatures and freezing at low temperatures in addition to unsuitability to use high voltage cathode materials.

Accordingly, there still exists a need for lithium batteries with improved characteristics, including energy density, capacity, lower self-discharge rates, cost, fast charging, and environmental safety.

### SUMMARY

Processes for preparing batteries comprising polymer matrix electrolytes are provided herein.

Aspects of the present disclosure provide a process of forming a battery cell, the process comprising: (a) feeding a positive current collector to a cathode depositing zone, (b) depositing on to the positive current collector a polymer-matrix electrolyte (PME)-cathode layer comprising at least one salt, at least one polymer, and at least one cathode active material is deposited onto the positive current collector; (c) feeding the PME-cathode layer to a PME depositing zone, (d) depositing onto the PME-cathode layer a PME layer to form a PME overcoated PME-cathode layer; (e) combining the PME overcoated PME-cathode layer with an anode to form a battery cell, and (f) interposing the PME layer between the PME-cathode layer and the anode, wherein the PME-cathode layer, PME layer, or both are in a solvated state throughout the process.

In some embodiments, operations (a)-(d) occur simultaneously.

In some embodiments, the PME-cathode layer in a solvated state comprises solvent and/or plasticizer in an amount of at least about 5% to about 20%, by weight, of a total weight of the PME-cathode layer. In some embodiments, the PME layer in a solvated state comprises solvent in an amount of at least about 5% to about 20%, by weight, of a total weight of the PME layer.

In some embodiments, the anode is a lithium metal anode. In some embodiments, the lithium metal anode further comprises a negative current collector.

In some embodiments, the anode is a PME-anode layer comprising at least one salt, at least one polymer, and at least one anode active material. In some embodiments, the PME-anode layer is in a solvated state comprising solvent in an amount of at least about 5% to about 20%, by weight, of a total weight of the PME-anode layer. In some embodiments, the process further comprises feeding a substrate to an anode depositing zone, depositing the PME-anode layer onto the substrate; feeding a negative current collector on top of the PME-anode, interposing the PME-anode layer between the substrate and the negative current collector anode; detaching the substrate from the PME-anode layer; and combining the PME-cathode layer with the PME-anode layer.

In some embodiments, the process further comprises laminating the PME-cathode layer to the anode layer.

In some embodiments, an area of the PME layer is about 0.5 mm to about 0.2 mm larger than an area of the PME-cathode layer in any dimension. In yet another embodiment, an area of the anode is the same as an area of the PME-cathode and less than an area of the PME layer.

In some embodiments, the salt is a lithium salt and comprises one or more of: LiCl, LiBr, LiI, Li(ClO₄), Li(BF₄), LiPF₆, Li(AsF₆), Li(CH₃CO₂), Li(CF₃SO₃), Li(CF₃SO₂)₂N, Li(CF₃SO₂)₃, Li(CF₃CO₂), Li(B(C₆H₅)₄), Li(SCN), LiB(C₂O₄)₂, Li(NO₃), lithium bis(trifluorosulfonyl)imide (LiTFSI), lithium bis(fluorosulfonyl)imide (LiFSI), lithium difluoro(oxalato)borate (LiDFOB) and lithium bis(oxalato)borate (LiBOB).

In some embodiments, the cathode active material is selected from the group comprising one or more of: lithium nickel cobalt manganese oxide (LiNiCoMnO₂) (NMC), lithium iron phosphate (LiFePO₄), lithium nickel manganese spinel (LiNi_{0.5}Mn_{1.5}O₄) (LNMO), lithium nickel cobalt aluminum oxide (LiNiCoAlO₂) (NCA), lithium manganese oxide (LiMn₂O₄) (LMO), and lithium cobalt oxide (LiCoO₂) (LCO).

In some embodiments, the at least one salt is a lithium salt and comprises one or more of: LiCl, LiBr, LiI, Li(ClO₄), Li(BF₄), LiPF₆, Li(AsF₆), Li(CH₃CO₂), Li(CF₃SO₃), Li(CF₃SO₂)₂N, Li(CF₃SO₂)₃, Li(CF₃CO₂), Li(B(C₆H₅)₄), Li(SCN), LiB(C₂O₄)₂, Li(NO₃), lithium bis(trifluorosulfonyl)imide (LiTFSI) and lithium bis(oxalato)borate (LiBOB).

In some embodiments, the anode active material comprises one or more of: carbonaceous materials; carbonaceous materials doped with silicon or tin; metallic lithium, a lithium alloy or a lithium compound; amorphous tin doped with cobalt or iron/nickel; an oxide selected from the group consisting of: iron oxide, ruthenium oxide, molybdenum oxide, tungsten oxide, titanium oxide and tin oxide; silicon oxides; and silicon nitrides. In some embodiments, the anode active material comprises one or more of: non-graphitic carbon, artificial carbon, artificial graphite, natural graphite, pyrolytic carbons and activated carbon.

In yet another embodiment, at least one polymer comprises one or more of: a fluorocarbon polymer; a polyacrylonitrile polymer; polyphenylene sulfide (PPS); poly(p-phenylene oxide) (PPE); a liquid crystal polymer (LCP); polyether ether ketone (PEEK); polyphthalamide (PPA); polypyrrole; polyaniline; polysulfone; an acrylate polymer; polyethylene oxide (PEO); polypropylene oxide (PPO); poly(bis(methoxy-ethoxy-ethoxide))-phosphazene (MEEP); polyacrylonitrile (PAN); polymethylmethacrylate (PMMA); polymethyl-acrylonitrile (PMAN); poly(ethylene glycol) diacrylate (PEGDA); a polyimide polymer; co-polymers including monomers of these polymers; and mixtures of these polymers.

Aspects of the present disclosure provide a process of forming a battery cell, the process comprising: (a) feeding a substrate to a first polymer-matrix electrolyte (PME) electrode depositing zone, (b) depositing a first PME electrode layer onto the substrate, wherein the PME electrode layer is either a PME-anode or PME-cathode layer; (c) feeding a current collector on top of the first PME electrode layer deposited onto the substrate, wherein the current collector is a positive current collector when the PME electrode layer is a PME-cathode or a negative current collector when the PME electrode layer is a PME-anode; (d) feeding the current collector to a second PME electrode depositing zone, (e) depositing a second PME electrode layer onto the current collector, (f) interposing the current collector between the first PME electrode layer and the second PME electrode layer, wherein the second PME electrode layer is the same as the first PME electrode layer; (g) detaching the substrate from the first PME electrode layer; (h) feeding the current collector interposed between the first PME electrode layer and the second PME electrode layer to a third PME depositing zone, (i) depositing a PME layer onto the first PME-electrode layer and the second PME electrode layer to form a first PME layer and a second PME layer; and (j) combining a first electrode layer to the first PME layer and a second electrode layer to the second PME layer to form a battery cell, wherein the first and second electrode layers are an anode when the first and second PME-electrode layers are a PME-cathode or the first and second electrode layers are a cathode when the first and second PME-electrode layers are a PME-anode, and wherein the first and second PME-electrode layers and first and second PME layers remain in a solvated state throughout the process.

In some embodiments, operations (a)-(g) occur simultaneously. In some embodiments, operations (a)-(h) are repeated at least once to form one or more battery cells. In yet another embodiment, the process further comprises stacking the one or more battery cells to form a multi-layer battery cell.

In some embodiments, operation (g) comprises depositing the second PME layer onto a substrate and combining the second PME layer with the second PME electrode layer. In some embodiments, the process further comprises removing the substrate from the second PME layer.

In some embodiments, the first and second PME-electrode layers in a solvated state comprise solvent in an amount of at least about 5% to about 20%, by weight, of a total weight of the PME-electrode layers. In yet another embodiment, the first and second PME layers in a solvated state comprise solvent in an amount of at least about 5% to about 20%, by weight, of a total weight of the first and second PME layers.

In some embodiments, the first and second electrode layer are an anode comprising a lithium metal.

In yet another embodiment, the first and second electrode layers are a PME-anode. In some embodiments, the battery cell comprises, sequentially, a first PME-anode layer, a first PME layer, a first PME-cathode layer, a centrally located common positive current collector, a second PME-cathode layer, a second PME layer, and a second PME-anode layer. In some embodiments, the process further comprises feeding a first negative current collector on top of the first PME-anode layer and a second negative current collector on top of the second PME-anode layer to form a battery cell sandwiched between the first and second negative current collectors.

In some embodiments, the first and second electrode layers are a PME-cathode. In some embodiments, the battery cell layer comprises, sequentially, a first PME-cathode layer, a first PME layer, a first PME-anode layer, a centrally located common negative current collector, a second PME-anode layer, a second PME layer, and a second PME-cathode layer. In yet another embodiment, the process further comprises feeding a first positive current collector on top of the first PME-cathode layer and a second positive current collector on top of the second PME-cathode layer to form a battery cell sandwiched between the first and second positive current collectors.

### BRIEF DESCRIPTION OF THE DRAWINGS

FIG. 1 is a flowchart illustrating an example process 100 for preparing a PME via a solution casting method in accordance with embodiments of the present disclosure.

FIG. 2 is an exemplary conductivity plot at different temperatures of a PME film prepared according to process 100 of FIG. 1 in accordance with embodiments of the present disclosure.

FIG. 3 is a flowchart illustrating an example process 300 for preparing a PME-cathode and/or PME-anode via a solution casting method in accordance with embodiments of the present disclosure.

FIGS. 4A-4C are exemplary schematics showing a cross-sectional view of the single-layer cells having layers arranged in various configurations in accordance with embodiments of the present disclosure.

FIG. 5 is an exemplary schematic of a cross-sectional view of a single-layer cell prepared in accordance with embodiments of the present disclosure.

FIG. 6 is an exemplary plot demonstrating the discharge rate capability test of the exemplary single-layer cell of FIG. 5 in accordance with embodiments of the present disclosure.

FIG. 7 shows an exemplary schematic of a cross-sectional view of a single-layer cell comprising a PME-cathode and an Li metal anode in accordance with embodiments of the present disclosure.

FIG. 8 is a diagram illustrating an example embodiment of a roll-to-roll process 800 for preparing single-layer cells with a composite anode (e.g., PME-anode) and composite cathode (e.g., PME-cathode) in accordance with embodiments of the present disclosure.

FIG. 9 shows an exemplary schematic of a multi-layer cell comprising PME-cathodes, PME-anodes, and a common positive current collector in accordance with embodiments of the present disclosure.

FIG. 10 is a diagram illustrating an example embodiment of a roll-to-roll process 1000 for preparing multi-layer cells comprising a single common positive current collector in accordance with embodiments of the present disclosure.

FIG. 11 is a diagram illustrating an example embodiment of a roll-to-roll process 1100 for preparing multi-layer cells comprising PME-cathodes, Li metal anodes, and a common positive current collector in accordance with embodiments of the present disclosure.

### DETAILED DESCRIPTION

To circumvent issues associated with LiBs, one of the most attractive alternative approaches is to replace the liquid electrolyte with a solid electrolyte. Most solid electrolytes offer advantages over liquid electrolytes, notably their flexibility to work with high voltage cathode materials and ability to suppress lithium dendrite penetration in addition to being non-flammable. Furthermore, solid batteries incorporating high-performance solid electrolytes are much safer and can provide higher capacity, higher energy density, and a longer cycle life.

Recently, tremendous efforts have been made for developing solid batteries, but progress is limited due to a lack of high-performance solid electrolytes and robust methods of manufacturing batteries with solid electrolytes. Nonetheless, limited progress in making solid batteries on a small scale have been made mainly using two promising families of solid electrolytes such as inorganic (e.g., oxides and sulfides) and solid polymer electrolytes. These solid electrolytes have advantages and disadvantages when used in making solid batteries. Inorganic solid electrolytes possess low to high ionic conductivity (10⁻⁶-10⁻² S/cm at room temperature) with a high lithium-ion transference number usually 1 or close to 1. Inorganic solid electrolytes are mostly in pellet, ceramic/glass plate, or powder forms, making their integration in large-format solid-state LiBs difficult to implement.

Sulfide solid electrolytes have high chemical reactivity with other components of the cell mainly with active materials causing high interfacial resistance. Moreover, there is need for constant mechanical press even for the small format solid batteries incorporating sulfide solid electrolytes which causes a huge drain in the overall energy density. This serves as another limiting factor for making solid batteries despite high ionic conductivity.

Likewise, the preparation process for oxide inorganic solid electrolytes and small format solid batteries using oxide inorganic solid electrolytes usually involves high temperature sintering processes which result in a high interfacial impedance among solid electrolyte particles due to poor contact, grain boundary effect, and chemical cross contamination reactivity with active materials. High temperature processing for making solid batteries using oxide solid electrolytes is necessary in order to maintain high ionic conductivity, but this process causes detrimental cross contamination thus leading to high interfacial impedance.

To address the limitations associated with manufacturing batteries with inorganic solid electrolytes, provided herein is a roll-to-roll manufacturing process for preparing battery cells featuring polymer matrix electrolytes (PMEs). PMEs enable the formation of safe, solid-state batteries with a high energy density and performance ability, allowing the PME batteries to function over a wide temperature range. These features are important and differentiate PME-based, solid-state LiBs from other potential solid-state batteries.

Described herein is a continuous, high-volume roll-to-roll production method for manufacturing dimensionally stable large-format high-performance solid-state LiBs using a lithium-ion conducting PME membrane. The solid-state LiBs described herein include a PME solid electrolyte layer that is sandwiched between a cathode layer and an anode layer. The batteries have a high lithium-ion conducting PME in both the anode and cathode structures and a thin PME layer, which functions as a solid-state electrolyte and separator. The PME layer maintains the physical and electrical continuity among the layers, yielding minimal interface resistance with stronger structural integrity.

Specifically, the present disclosure describes a high throughput roll-to-roll streamline method of manufacturing dimensionally stable large-format solid batteries with a high yield. Salient features of the PME such as: (i) high ionic conductivity at room temperature as well at low temperature unlike other comparable solid electrolytes, (ii) stability at high voltage and suitability for working with energy rich high voltage cathode materials, (iii) ability to form very thin and large area electrolyte and electrode membranes, (iv) high mechanical flexibility allowing the polymer to conform to electrode surfaces and maintaining structural stability with the electrode materials during cycling, (v) ability to form a very thin PME solid electrolyte membrane sandwiched between and interlockingly with the PME integrated anode and cathode structures that provides low interfacial resistance, and (vi) ability to suppress lithium penetrability during cycling of the solid-state LiBs because of their high mechanical moduli enable the use of the PME in the high-throughput processes described herein. Solid batteries made in accordance to embodiments of present disclosure are large format, energy dense, long cycle life, high C-rate capable, and operational at wide temperature ranges.

### Definitions

As used herein, the term “about” when used to modify a numerical value means a value that is within 10% of that numerical value (i.e., +/−10%).

### Methods for Making Single-Layer Cells and the Corresponding Components

I. Methods of Making the PME

The present disclosure provides methods of preparing solid PME via a solution casting method. The PME comprises at least a solvent, at least one polymer, and at least one lithium salt. In some embodiments, the PME is neither a liquid nor gel but rather is a solid-state material. Moreover, unlike conventional gel or liquid electrolytes, all of the PME components (i.e., solvent, polymer, and a lithium salt) participate in ionic conduction as well as provide mechanical support to the solid-state electrolyte layer.

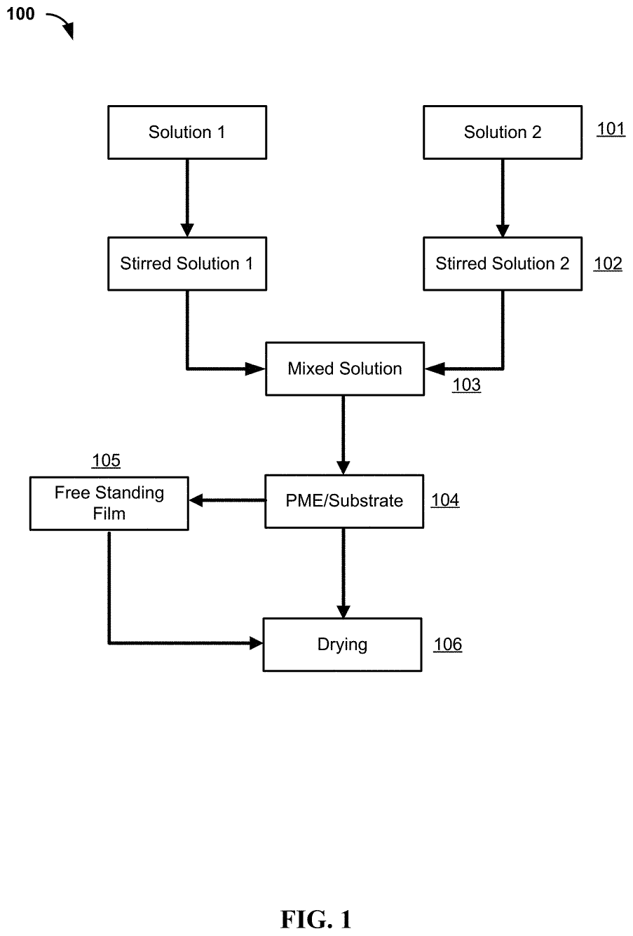

FIG. 1 is a flow chart illustrating an example process 100 for preparing a PME via a solution casting method in accordance with embodiments of the present disclosure. At step 101, process 100 begins by preparing two separate precursor solutions. The first precursor solution is prepared by adding a one or more base polymers to a solvent. Non-limiting examples of base polymers include: polyvinyl chloride (PVC), GPI-15 polyimide, polyimide (PI), chlorinated polyvinyl chloride (CPVC), polystyrene (PS), polyethylene oxide (PEO), polymethylmethacrylate (PMMA), polyacrylonitrile (PAN), and thermoplastic acrylic resin PEO, poly(propylene oxide) (PPO), poly(vinylidene fluoride) (PVdF), poly(vinylidene fluoride-hexafluoropropylene) (PVdF-HFP), polyurethane (PET), polyacrylamide (PAA), poly(vinyl acetate) (PVA), polyvinylpyrrolidone (PVP), Poly(ethylene glycol) diacrylate (PEGDA), polyester, polypropylene (PP), polyethylene naphthalate (PEN), polycarbonate (PC), polyphenylene sulfide (PPS), polytetrafluoroethylene (PTFE), poly(p-phenylene oxide) (PPE), polypyrrole, polyaniline, polysulfone, acrylate polymer, polymethyl-acrylonitrile (PMAN), and polyimide polymer. In some embodiments, polymers include co-polymers comprising monomers of these polymers and/or mixtures of these polymers.

The second precursor solution is prepared by adding one or more lithium salts to a solvent. Non-limiting examples of lithium salts include: LiCl, LiBr, LiI, Li(ClO₄), Li(BF₄), Li(PF₆), Li(AsF₆), Li(CH₃CO₂), Li(CF₃SO₃), Li(CF₃SO₂)₂N, Li(CF₃SO₂)₃, Li(CF₃CO₂), Li(B(C₆H₅)₄), Li(SCN), LiBOB, and Li(NO₃). In some embodiments, the first and second precursor solutions are prepared from either a single solvent or a mixture of one or more solvents. Non-limiting examples of suitable solvents include N-methylpyrrolidone (NMP), anhydrous ethanol, dimethylacetamide (DMAc), dimethyl sulfoxide (DMSO), dimethylformamide (DMF), tetrahydrofuran (THF), trimethyl phosphate (TMP), triethyl phosphate (TEP), gamma-butyrolactone (GBL), and ethyl acetate. In some embodiments, the solvent comprises organic esters of carbonic acid with the linear or cyclic structure, namely, e.g., dialkyl and alkene carbonates. Non-limiting examples of dialkyl and alkene carbonates solvents include ethylene carbonate (EC), dimethyl carbonate (DMC), diethyl carbonate (DEC), and ethylmethyl carbonate (EMC). In some embodiments, the solutions are slurries (e.g., the base polymer(s) or the lithium salt(s) does not fully dissolve in the solvent). In some embodiments, the solutions are prepared at room temperature (e.g., 25° C.).

In some embodiments, the one or more base polymers are present in the first solution in an amount about 10% to about 40%, by weight and/or volume, of the total weight and/or volume of the first solution. In some embodiments, one or more base polymers are present in an amount up to about 60%, by weight and/or volume, of the total weight and/or volume of the solution for more soluble polymers (e.g., PVdF and PVdF-HFP). In some embodiments, the solution can include one or more polymers to tune the mechanical strength, thermal stability, and/or ionic conductivity of the resulting PME. For example, in some embodiments, a specific polymer is chosen to provide high mechanical strength and thermal stability, and a different polymer is chosen to provide high ionic conductivity to the PME. In some embodiments, the combination of the two or more polymers comprises PVdF or PVdF-HFP with GPI-15 PI or PI. In some embodiments, the combination of the two or more polymers comprises PVdF with GPI-15 PI. In some embodiments, the combination of the two or more polymers comprises PVdF-HFP with GPI-15 PI. In some embodiments, the combination of the two or more polymers comprises PVdF-HFP with PI. In some embodiments, the combination of the two or more polymers comprises PVdF with PI.

The process 100 can continue in step 102 where the first solution comprising the one or more polymers and the second solution comprising the one or more lithium salts are separately stirred. In some embodiments, the stirring includes milling the solutions by stirring the solutions at a speed of about 100 rpms to about 1000 rpms. In some embodiments, the slurries are milled for about 12 hours to about 48 hours. The process 100 can continue in step 103 where the first and second solution are combined and stirred. In some embodiments, mixing the first and second solutions includes milling the solutions at the same or different speeds at which the individual solutions were milled. In some embodiments, the speed of milling depends on the viscosity of the solutions. In some embodiments, the solutions are stirred for about 24 hours to about 36 hours. This approach provides a homogeneous mixture, which produces a PME with high conductivity.

In some embodiments, mechanical and electrochemical properties of the PME can be tuned by controlling the amount of polymer present in the solution. In some embodiments, the polymer is present in the resulting mixed solution and/or the first solution in an amount of about 10% to about 50%, by weight and/or volume, of the total weight and/or volume of the solution. For example, about 10%, about 15%, about 20%, about 25%, about 30%, about 35%, about 40%, about 45%, or about 50%, by weight and/or volume, of the total weight and/or volume of the solution. In some embodiments, the mixed solution has a polymer to salt ratio of about 60 to about 40, about 40 to about 60, or about 50 to about 50. In some embodiments, the polymer to salt ratio of the mixed solution is about 60 to about 40.

The process 100 can continue in step 104 where the mixed solution is cast onto a substrate. In some embodiments, the combined solution comprising the one or more base polymers, one or more lithium salts, and one or more solvents is processed onto a high dielectric substrate (e.g., Mylar sheet). In another embodiment, the combined solution comprising the one or more base polymers, one or more lithium salts, and one or more solvents is processed onto a well adherable substrate such as a negative or positive electrode already formed on metallic substrate for cell assembly. The process 100 can continue in step 105 where the PME is removed from the substrate to form a free standing PME film.

The process 100 can continue in step 106 where the PME free standing films and/or PME overcoated electrodes (e.g., negative or positive electrodes) are dried. In some embodiments, the PME free standing films and/or PME overcoated electrodes are dried in a convection oven at a temperature ranging from about 50° C. to about 120° C. for about 0.1 hours to about 12 hours. In some embodiments, the PME free standing films and/or PME overcoated electrodes are dried continuously or intermittently before further characterization. After drying, a PME is formed that is neither liquid nor gel but rather is a solvated solid material where all the components, e.g., solvent, polymer, and salt, can participate in ionic conduction and provide mechanical support to the dry PME.

In some embodiments, after drying the PME, the PME remains in a solvated state (e.g., the PME retains solvent). In some embodiments, the PME in the solvated state comprises solvent in an amount of about 5% to about 20%, by weight, of a total weight of the PME. For example, about 5%, about 6%, about 7%, about 8%, about 9%, about 10%, about 11%, about 12%, about 13%, about 14%, about 15%, about 16%, about 17%, about 18%, about 19%, or about 20%, by weight, of a total weight of the PME. By remaining in a solvated state, the PME can be used directly in processes for preparing battery cells comprising the PME without an additional re-wetting set to activate the PME. Re-wetting activates the PME and comprises adding sufficient solvent and/or a plasticizer to solvate the PME. In the solvated state, the salt is able to dissociate into its component ions—anions and cations. Once dissociated, the cations and anions are able to move through the PME to create the ion current. In the activated, solvated state the PME is also adhesive and able to achieve adherence between the various layers of the battery cell. This contrasts with other processes for preparing battery cells that require re-wetting of a fully dried PME layer in order to achieve activation and adherence between the various layers within the battery cell. In some embodiments, the process does not require an additional step of activating the PME layer by re-wetting.

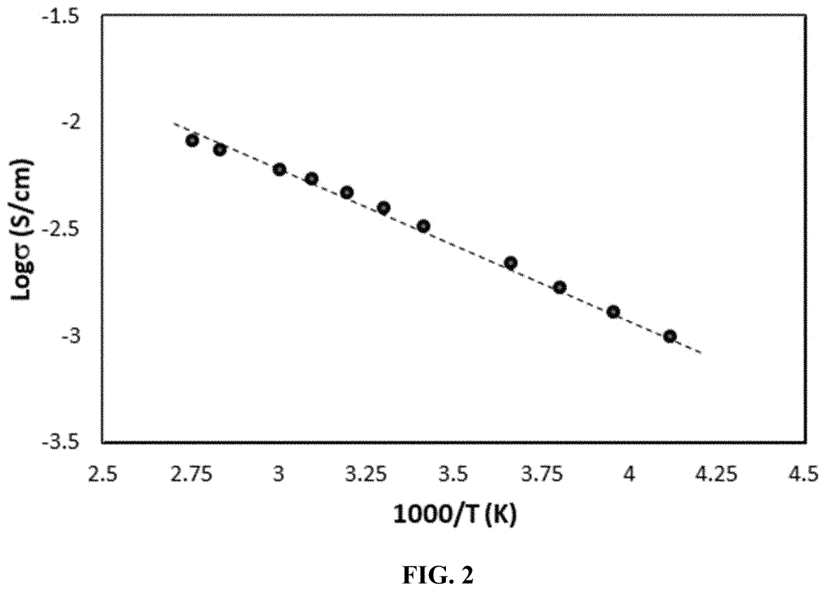

FIG. 2 shows a conductivity plot of an exemplary PME prepared according to the process 100 at different temperatures. FIG. 2 demonstrates that the PME has a conductivity (e.g., 10⁻³ to 10⁻⁴ S/cm) over a −30° C. to 100° C. temperature range; an Arrhenius type behavior for temperature dependence of its ionic conductivity with apparent activation energy, Eₐ, of about 13.6 kJ/mol, which is on lower side of typical values for solid polymer electrolytes; voltage stability up to 4.5V; compatibility with high voltage stable cathode materials (e.g., NMC); high mechanical strength; stability with common liquid electrolytes; ability to be produced at thicknesses as thin as 5-30 micron; and manufacturability at large volumes.

II. Methods of Making the PME-Cathode and PME-Anode

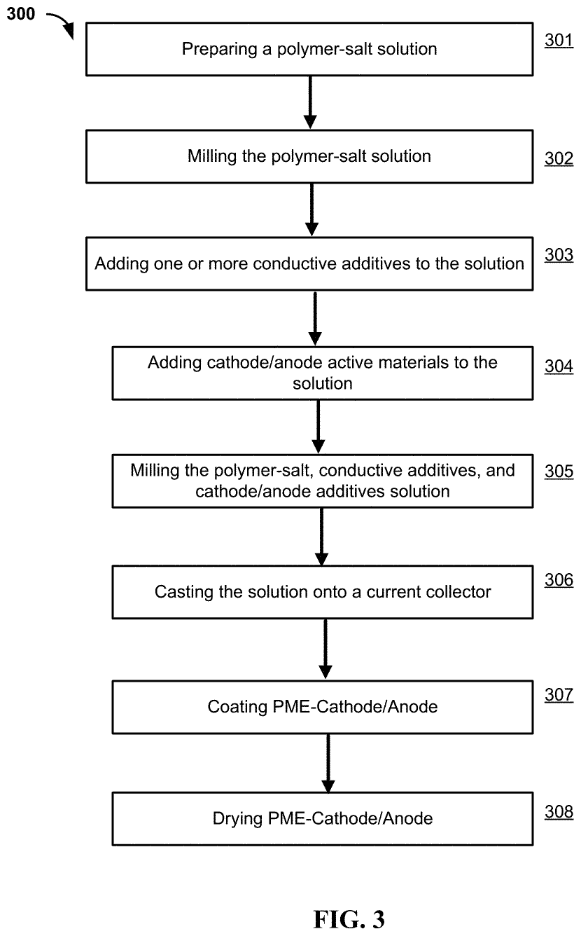

The present disclosure provides methods of preparing solid PME cathodes and anodes via a solution casting method. FIG. 3 is a flowchart illustrating an example process 300 for preparing a PME-cathode and/or PME-anode via a solution casting method in accordance with embodiments of the present disclosure. At step 301, process 300 begins by preparing a polymer-salt solution. In some embodiments, the salt is a lithium salt selected from one or more of LiCl, LiBr, LiI, Li(ClO₄), Li(BF₄), Li(PF₆), Li(AsF₆), Li(CH₃CO₂), Li(CF₃SO₃), Li(CF₃SO₂)₂N, Li(CF₃SO₂)₃, Li(CF₃CO₂), Li(B(C₆H₅)₄), Li(SCN), LiBOB, and Li(NO₃). In some embodiments, the polymer is one or more of N-methylpyrrolidone (NMP), anhydrous ethanol, dimethylacetamide (DMAc), dimethyl sulfoxide (DMSO), dimethylformamide (DMF), tetrahydrofuran (THF), trimethyl phosphate (TMP), triethyl phosphate (TEP), gamma-butyrolactone (GBL), and ethyl acetate. In some embodiments, the solvent comprises organic esters of carbonic acid with the linear or cyclic structure, namely, e.g., dialkyl and alkene carbonates. Non-limiting examples of dialkyl and alkene carbonates solvents include ethylene carbonate (EC), dimethyl carbonate (DMC), diethyl carbonate (DEC), and ethylmethyl carbonate (EMC). The process 300 can continue in step 302 where the polymer-salt solution is milled using both planetary and overhead milling stations, consecutively. In some embodiments, the planetary milling is carried out for about 1 minute to about 30 minutes at a speed of about 1 rpm to about 3000 rpm. In some embodiments, the overhead milling is carried out for about 1 hour to about 3 hours at a speed of about 50 rpm to about 3000 rpm.

The process 300 can continue in step 303 where one or more electronically conductive additives are added to the milled solution. Electronically conductive additives added to the milled solution when manufacturing the PME-cathode include carbon-based conductive additives such as KS4 and C65, super P, nano-tubes, carbon fibers, etc. The process 300 can continue in step 304 where cathode active material and/or anode active material is added to the milled solution. In some embodiments, the cathode active material and/or the anode active material in step 304 can be added before the electronically conductive additives in step 303.

Non-limiting examples of cathode active materials include lithium nickel cobalt manganese oxide (LiNiCoMnO₂) (NMC), lithium iron phosphate (LiFePO₄), lithium nickel manganese spinel (LiNi_{0.5}Mn_{1.5}O₄) (LNMO), lithium nickel cobalt aluminum oxide (LiNiCoAlO₂) (NCA), lithium manganese oxide (LiMn₂O₄) (LMO), and lithium cobalt oxide (LiCoO₂) (LCO).

In some embodiments, the cathode active material can be a compound of the following general formula LixNiaMnbCocO, where x ranges from about 0.05 to about 1.25, c ranges from about 0.1 to about 0.4, b ranges from about 0.4 to about 0.65, and a ranges from about 0.05 to about 0.3.

In some embodiments, the cathode active material can be a compound of the following general formula LixAyMaM′bO₂, where M and M′ are at least one member of the group consisting of iron, manganese, cobalt, and magnesium; A is at least one member of the group consisting of sodium, magnesium, calcium, potassium, nickel, and niobium; x ranges from about 0.05 to 1.25; y ranges from 0 to 1.25, M is Co, Ni, Mn, Fe; a ranges from 0.1 to 1.2; and b ranges from 0 to 1.

In yet another embodiment, the cathode active material can be an olivine compound represented by the general formula LixAyMaM′bPO₄, where M and M′ are independently at least one member of the group consisting of iron, manganese, cobalt, and magnesium; A is at least one member of the group consisting of sodium, magnesium, calcium, potassium, nickel, and niobium; x ranges from about 0.05 to 1.25; y ranges from 0 to 1.25; a ranges from 0.1 to 1.2; and b ranges from 0 to 1. According to some embodiments, M can be Fe or Mn. According to some embodiments, the olivine compound is LiFePO₄ or LiMnPO₄ or combinations thereof. According to some embodiments, the olivine compounds are coated with a material having high electrical conductivity such as carbon. According to some embodiments, the coated olivine compounds can be carbon-coated LiFePO₄ or carbon-coated LiMnPO₄.

In some embodiments, the cathode active material can be a manganate spinel represented by an empirical formula of LiMn2O₄.

In some embodiments, the cathode active material can be a spinel material represented by the general formula LixAyMaM′bO₄, where M and M′ are independently at least one member of the group consisting of iron, manganese, cobalt, and magnesium; A is at least one member of the group consisting of sodium, magnesium, calcium, potassium, nickel, and niobium; x is from about 0.05 to 1.25; y is from 0 to 1.25; a is from 0.1 to 1.2; and b ranges from 0 to 1.

Non-limiting examples of anode active materials include carbonaceous materials, for example, non-graphitic carbon, artificial carbon, artificial graphite, natural graphite, pyrolytic carbons, cokes such as pitch coke, needle coke, petroleum coke, graphite, vitreous carbons, or a heat treated organic polymer compound obtained by carbonizing phenol resins, furan resins, or similar, carbon fibers, and activated carbon.

In some embodiments, metallic lithium, lithium alloys, and an alloy or compound thereof can be used as the negative active materials. The metal element or semiconductor element used to form an alloy or compound with lithium may be a group IV metal element or semiconductor element including, but not limited to, silicon or tin (e.g., amorphous tin that is doped with a transition metal). In some embodiments, the anode active material comprises an amorphous tin or silicon doped with graphite or any of the aforementioned carbonaceous materials, cobalt, or iron/nickel. In some embodiments, the anode material can comprise oxides allowing lithium to be inserted in or removed from the oxide at a relatively low potential. Exemplary oxides include, but are not limited to, iron oxide, ruthenium oxide, molybdenum oxide, tungsten oxide, titanium oxide, and tin oxide. Silicon oxides and nitrides can also be used as the negative active materials.

In yet another embodiment, the negative or anode active material can comprise lithium titanate (LTO).

In some embodiments, the electronically conductive additives in step 303 and the cathode active material and/or anode active material in step 304 are added while the solution comprising the polymer and salt is being milled. The process 300 can continue in step 305 where the solution comprising the polymer, salt, electronically conductive additives, and the cathode active material and/or anode active material are milled for about 1 hour to about 24 hours at a speed of about 500 rpm to about 3000 rpm.

Table 1 shows an exemplary cathode formulation including the amount of cathode active material, polymer, lithium salt, and electronically conductive additives in the solution. In this example formulation, the solution comprises two conductive additives.

TABLE 1
PME-Cathode Formulation

| | Quantity |
|---|---|
| PME-Cathode Component | Range (wt. %) |
| Active material (e.g., NMC) | 50-95 |
| Polymer | 1-30 |
| Lithium Salt | 1-30 |
| Conductive Additive 1 | 1-5 |
| Conductive Additive 2 | 1-5 |

In some embodiments, the active material is present in the PME-cathode formulation in an amount of about 50% to about 95%, by weight, of the total weight of the PME-cathode formulation. For example, in some embodiments, the active material is present in the PME-cathode formulation in an amount of about 50% to about 60%, about 50% to about 70%, about 50% to about 80%, about 50% to about 90%, about 80% to about 95%, about 70% to about 95%, about 60% to about 95%, about 70% to about 80%, about 60% to about 80%, or about 65% to about 75%, by weight, of the total weight of the PME-cathode formulation. For example, in some embodiments, the active material is present in the PME-cathode formulation in an amount of about 50%, about 60%, about 70%, about 75%, about 80%, about 90%, or about 95%, by weight, of the total weight of the PME-cathode formulation.

In some embodiments, the one or more polymers are present in the PME-cathode formulation in an amount of about 1% to about 30%, by weight, of the total weight of the PME-cathode formulation. For example, in some embodiments, the one or more polymers are present in the PME-cathode formulation in an amount of about 1% to about 5%, about 1% to about 10%, about 1% to about 15%, about 1% to about 20%, about 1% to about 25%, about 25% to about 30%, about 20% to about 30%, about 10% to about 30%, about 5% to about 20%, or about 5% to about 15%, by weight, of the total weight of the PME-cathode formulation. For example, in some embodiments, the one or more polymers are present in the PME-cathode formulation in an amount of about 1%, about 5%, about 15%, about 20%, about 25%, or about 30%, by weight, of the total weight of the PME-cathode formulation.

In some embodiments, the one or more lithium salts are present in the PME-cathode formulation in an amount of about 1% to about 30%, by weight, of the total weight of the PME-cathode formulation. For example, in some embodiments, the one or more lithium salts are present in the PME-cathode formulation in an amount of about 1% to about 5%, about 1% to about 10%, about 1% to about 15%, about 1% to about 20%, about 1% to about 25%, about 25% to about 30%, about 20% to about 30%, about 10% to about 30%, about 5% to about 20%, or about 5% to about 15%, by weight, of the total weight of the PME-cathode formulation. For example, in some embodiments, the one or more lithium salts are present in the PME-cathode formulation in an amount of about 1%, about 5%, about 15%, about 20%, about 25%, or about 30%, by weight, of the total weight of the PME-cathode formulation.

In some embodiments, the one or more conductive additives are present in the PME-cathode formulation in an amount of about 1% to about 5%, by weight, of the total weight of the PME-cathode formulation. For example, in some embodiments, the conductive additives are present in the PME-cathode formulation in an amount of about 1% to about 2%, about 1% to about 3%, or about 1% to about 4%, by weight, of the total weight of the PME-cathode formulation. For example, in some embodiments, the one or more conductive additives are present in the PME-cathode formulation in an amount of about 1%, about 2%, about 3%, about 4%, or about 5%, by weight, of the total weight of the PME-cathode formulation.

Table 2 shows an exemplary anode formulation including the amount of anode active material, polymer, lithium salt, and electronically conductive additives in the solution.

TABLE 2
PME-Anode Formulation

| | Quantity |
|---|---|
| PME-Anode Component | Range (wt. %) |
| Active material (e.g., graphite) | 70-90 |
| Polymer | 1-20 |
| Lithium Salt | 1-20 |
| Conductive Additive | 1-5 |

In some embodiments, the active material is present in the PME-anode formulation in an amount of about 70% to about 90%, by weight, of the total weight of the PME-anode formulation. For example, in some embodiments, the active material is present in the PME-anode formulation in an amount of about 70% to about 75%, about 70% to about 80%, or about 70% to about 85%, by weight, of the total weight of the PME-anode formulation. For example, in some embodiments, the active material is present in the PME-anode formulation in an amount of about 70%, about 75%, about 80%, about 85%, or about 90%, of the total weight of the PME-anode formulation.

In some embodiments, the one or more polymers are present in the PME-anode formulation in an amount of about 1% to about 20%, by weight, of the total weight of the PME-anode formulation. For example, in some embodiments, the one or more polymers are present in the PME-anode formulation in an amount of about 1% to about 5%, about 1 to about 10%, about 1% to about 15%, or about 1% to about 20%, about 10% to about 20%, about 5% to about 20%, or about 5% to about 15%, by weight, of the total weight of the PME-anode formulation. For example, in some embodiments, the one or more polymers are present in the PME-anode formulation in an amount of about 1%, about 5%, about 15%, or about 20%, by weight, of the total weight of the PME-anode formulation.

In some embodiments, the one or more lithium salts are present in the PME-anode formulation in an amount of about 1% to about 20%, by weight, of the total weight of the PME-anode formulation. For example, in some embodiments, the one or more lithium salts are present in the PME-anode formulation in an amount of about 1% to about 5%, about 1% to about 10%, about 1% to about 15%, or about 1% to about 20%, about 10% to about 20%, about 5% to about 20%, or about 5% to about 15%, by weight, of the total weight of the PME-anode formulation. For example, in some embodiments, the one or more lithium salts are present in the PME-anode formulation in an amount of about 1%, about 5%, about 15%, or about 20%, by weight, of the total weight of the PME-anode formulation.

In some embodiments, the one or more conductive additives are present in the PME-anode formulation in an amount of about 1% to about 5%, by weight, of the total weight of the PME-anode formulation. For example, in some embodiments, the conductive additives are present in the PME-anode formulation in an amount of about 1% to about 2%, about 1% to about 3%, or about 1% to about 4%, by weight, of the total weight of the PME-anode formulation. For example, in some embodiments, the one or more conductive additives are present in the PME-anode formulation in an amount of about 1%, about 2%, about 3%, about 4%, or about 5%, by weight, of the total weight of the PME-anode formulation.

The process 300 can continue in step 306 where the PME-cathode solution and/or PME-anode is cast onto a current collector. In some embodiments, the PME-cathode solution is cast onto a current collector where the current collector is either aluminum or carbon coated aluminum. In some embodiments, the PME-anode solution is cast onto a current collector where the current collector is either nickel or carbon coated nickel or copper. In some embodiments, the current collector has a thickness of about 3 microns to about 30 microns. For example, about 5 microns, about 10 microns, about 15 microns, about 20 microns, about 25 microns, or about 30 microns. In some embodiments, the carbon coating of the carbon coated aluminum, nickel, or copper has a thickness of 100 nm to 5 pm. For example, a thickness of about 100 nm, about 500 nm, about 1 pm, or about 5 pm. In some embodiments, the aluminum or carbon coated aluminum current collector has a thickness of about 5 microns to about 30 microns. In some embodiments, the nickel or carbon coated nickel or copper current collector has a thickness of about 3 microns to about 30 microns. In some embodiments, the PME-cathode solution and/or the PME-anode solution has a viscosity of about 1,000 centipoise (cP) to about 25,000 cP. For example, about 1,000 cP, about 5,000 cP, about 10,000 cP, about 15,000 cP, about 20,000 cP, or about 25,000 cP. In some embodiments, the PME-anode solution has a viscosity of about 9,000 cP. In some embodiments, the viscosity of the PME-cathode solution and the PME-anode solution is determined prior to the casting step 306.

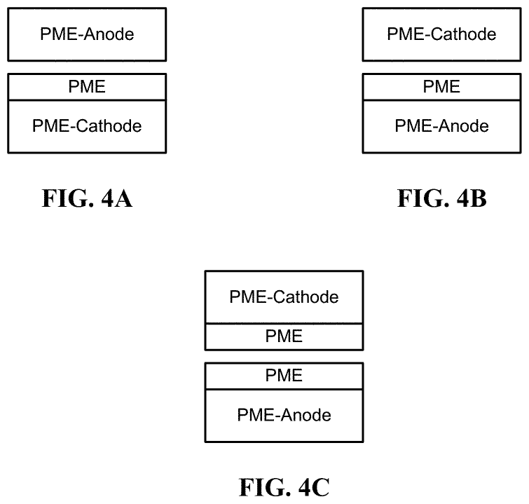

The process 300 can continue in step 307 where the PME-cathode and/or the PME-anode is coated with a PME layer (see FIGS. 4A-4C). In some embodiments, the step 307 includes coating the PME-cathode or PME-anode using either a lab scale or doctor blade table-top coater. In other embodiments, the step 307 includes coating the PME-cathode and/or PME-anode with a prototype roll-to-roll coater.

The process 300 can continue in step 308 where the PME-cathode and/or PME-anode is dried. In some embodiments, the PME-cathode and/or PME-anode coated via a doctor blade table-top coater is dried at temperature of about 50° C. to about 120° C. in a convection oven. In some embodiments, the PME-cathode and/or PME-anode coated via a doctor blade table-top coater is dried for about 1 hour to about 12 hours either continuously or intermittently. In some embodiments, the PME-cathode and/or PME-anode coated via a roll-to-roll coater is dried in an in-line oven dryer.

In some embodiments, after drying, the PME-cathode and/or the PME-anode remain in a solvated state (e.g., the PME-cathode and/or PME-anode retains solvent). In some embodiments, the PME-cathode and/or the PME-anode in the solvated state comprise solvent in an amount of about 5% to about 20%, by weight, of a total weight of the PME-cathode and/or the PME-anode. For example, about 5%, about 6%, about 7%, about 8%, about 9%, about 10%, about 11%, about 12%, about 13%, about 14%, about 15%, about 16%, about 17%, about 18%, about 19%, or about 20%, by weight, of a total weight of the PME-cathode and/or the PME-anode. By remaining in a solvated state, the PME-cathode and/or the PME-anode can be used directly in processes for preparing battery cells comprising the PME-cathode and/or the PME-anode without an additional activation/re-wetting step. In some embodiments, the process does not require the additional step of activation/re-wetting the PME-cathode and/or the PME-anode.

The process 300 can continue in step 308 where the PME-cathode and/or PME-anode is compacted by calendering. Calendering is a process by with the layers of the battery cell are compressed at elevated temperature, pressure, and speed. Step 308 includes calendering the PME-cathode and/or PME-anode one or more times at an elevated temperature that does not exceed 120° C.

In some embodiments, a PME-cathode made according to process 300 has good adhesion with a current collector foil as well as with cathode active material particles and displays no signs of microcracks in the cross-section. In some embodiments, the PME-cathode made according to process 300 has a thickness of about 10 microns to 80 microns. For example, about 10 microns, about 20 microns, about 30 microns, about 40 microns, about 50 microns, about 60 microns, about 70 microns, or about 80 microns. In some embodiments, the PME-cathode made according to process 300 has a single-sided areal capacity of 1 to 3 mAh/cm². In some embodiments, the PME-cathode made according to process 300 has a porosity of 10% to about 40% of the total volume of the PME-cathode. In some embodiments, the PME-cathode made according to process 300 has a thickness of about 10 microns to about 80 microns, a single-sided areal capacity of 1 to 3 mAh/cm², and a porosity of about 10% to about 40% of a total volume of the PME-cathode.

In some embodiments, a PME-anode made according to process 300 has good adhesion with a current collector foil as well as with anode active material particles and displays no signs of microcracks in the cross-section. In some embodiments, the PME-anode made according to process 300 has a thickness of about 10 microns to 60 microns. For example, about 10 microns, about 20 microns, about 30 microns, about 40 microns, about 50 microns, or about 60 microns. In some embodiments, the PME-anode made according to process 300 has a single-sided areal capacity of 1 to 3 mAh/cm². In some embodiments, the PME-anode made according to process 300 has a porosity of 10% to about 40% of the total volume of the PME-anode. In some embodiments, the PME-anode made according to process 300 has a thickness of about 10 microns to about 60 microns, a single-sided areal capacity of 1 to 3 mAh/cm², and a porosity of about 10% to about 40% of a total volume of the PME-anode.

III. PME Overcoat on PME-cathode and PME-anode

The present disclosure provides methods of coating PME-cathodes and PME-anodes with a PME layer. In some embodiments, the PME-cathode and/or PME-anode made according to process 300 is coated with a PME made according to process 100. In some embodiments, a PME solution made in step 103 of process 100 is cast onto a PME-cathode and/or PME-anode, wherein the PME-cathode and/or PME-anode are porous. The porosity of the PME-cathode and/or PME-anode facilitates large volume impregnation of the PME solution into the PME-cathode and/or PME-anode. In some embodiments, the PME layer is added to the PME-cathode and/or PME-anode layer, wherein the PME-cathode and/or the PME-anode are in a solvated state. In some embodiments, the process does not require the additional step of activation/re-wetting the PME-cathode, the PME-anode, and/or the PME layer. In some embodiments, a larger depth impregnation of the PME solution into the PME-cathode and/or PME-anode is achieved by deploying multiple infiltrations. In some embodiments, a larger depth impregnation of the PME solution into the PME-cathode and/or PME-anode is achieved by varying the viscosity of the PME solution. In some embodiments, after impregnation of the PME-cathode and/or PME-anode with the PME solution, the PME-anode and/or PME-cathode layered with the PME layer are dried. In some embodiments, the impregnated PME-anode and impregnated PME-cathode are dried in an oven at about 50° C. to about 120° C. for about 0.5 hours to about 12 hours.

In some embodiments, after drying, the PME coated PME-cathode and/or the PME-anode remain in a solvated state (e.g., the PME coated PME-cathode and/or PME-anode retains solvent). In some embodiments, the PME coated PME-cathode and/or the PME-anode in the solvated state comprise solvent in an amount of about 5% to about 20%, by weight, of a total weight of the PME coated PME-cathode and/or the PME-anode. For example, about 5%, about 6%, about 7%, about 8%, about 9%, about 10%, about 11%, about 12%, about 13%, about 14%, about 15%, about 16%, about 17%, about 18%, about 19%, or about 20%, by weight, of a total weight of the PME coated PME-cathode and/or the PME-anode. By remaining in a solvated state, the PME coated PME-cathode and/or the PME-anode can be used directly in processes for preparing battery cells comprising the PME coated PME-cathode and/or the PME-anode without an additional activation/re-wetting step. In some embodiments, the process does not require the additional step of activation/re-wetting the PME coated PME-cathode and/or the PME-anode.

After drying, a thin, dense, and homogeneous layer of PME is retained on the surface of PME-cathode and/or PME-anode to function as a solid-state lithium-ion conducting electrolyte sandwich between the PME-cathode and/or PME-anode in the full solid-state LiBs. In some embodiments, the impregnation process and drying step ensures retention of a thin PME layer with thickness in the range of 5 microns to 25 microns over the PME-cathode and/or PME-anode. For example, about 5 microns, about 10 microns, about 15 microns, about 20 microns, or about 25 microns. This process ensures impregnation of the PME-electrode pores and continuous presence of PME with minimal interface resistance.

IV. Process of Forming Single-Layer Cells with a Composite Anode and Cathode

The present disclosure provides methods of making single-layer cells comprising at least one PME-anode, at least one PME-cathode, and at least one PME layer sandwiched by an anode and cathode. In some embodiments, the single-layer cells can include arranging the various layers of the cells in different configurations. The different layers can be arranged in various configurations because the layers exhibit strong interlayer adhesion and can be laminated together, providing low interfacial resistance via bonding with both negative and positive current collectors and with the electrode components.

In some embodiments, the single-layer cells comprise a PME-anode, PME-cathode, and at least one PME layer. FIGS. 4A-4C are exemplary schematics showing a cross-sectional of the single-layer cells having layers arranged in various configurations in accordance with embodiments of the present disclosure. In some embodiments, the single-layer cell is prepared by laminating a PME-cathode coated with a PME layer to a PME-anode as shown in FIG. 4A. In some embodiments, the single-layer cell is prepared by laminating the PME-anode coated with a PME layer to a PME-cathode as shown in FIG. 4B. In yet another embodiment, the single-layer cell is prepared by laminating a PME-cathode coated with a PME layer to a PME-anode coated with a PME layer as shown in FIG. 4C.

In some embodiments, the process of laminating one layer to another layer is carried out at a temperature of about 50° C. to about 130° C. and by placing the layers between two heated hotplates. In some embodiments, laminating one layer to another layer includes intermittent laminating where the heat is removed and reapplied several times. Intermittent laminating can provide strong contact between the layers with minimal interface resistance. In some embodiments, the intermittent laminating includes heating the layers for about 1 minute to about 60 minutes and then removing the heat from about 1 minute to about 60 minutes. In some embodiments, the heat is reapplied about 1 time to about 20 times during the laminating process. In some embodiments, the single-layer cells can have capacities from as low as a few milli-Ampere-hours (mAh) to Ampere-hours (Ah).

In some embodiments, the PME-cathode, PME-anode, and/or PME layer are in a solvated state prior to the lamination step. In some embodiments, the PME-cathode, PME-anode, and/or PME layer in the solvated state comprise solvent in an amount of about 5% to about 20%, by weight, of a total weight of the PME-cathode, PME-anode, and/or PME layer. For example, about 5%, about 6%, about 7%, about 8%, about 9%, about 10%, about 11%, about 12%, about 13%, about 14%, about 15%, about 16%, about 17%, about 18%, about 19%, or about 20%, by weight, of a total weight of the PME-cathode, PME-anode, and/or PME layer. By remaining in a solvated state, the PME-cathode, PME-anode, and/or PME layer can be used directly in processes for preparing battery cells comprising the PME-cathode, PME-anode, and/or PME layer without an additional activation/re-wetting step. In some embodiments, the process does not require an additional step of activation/re-wetting the PME-cathode, PME-anode, and/or PME layer.

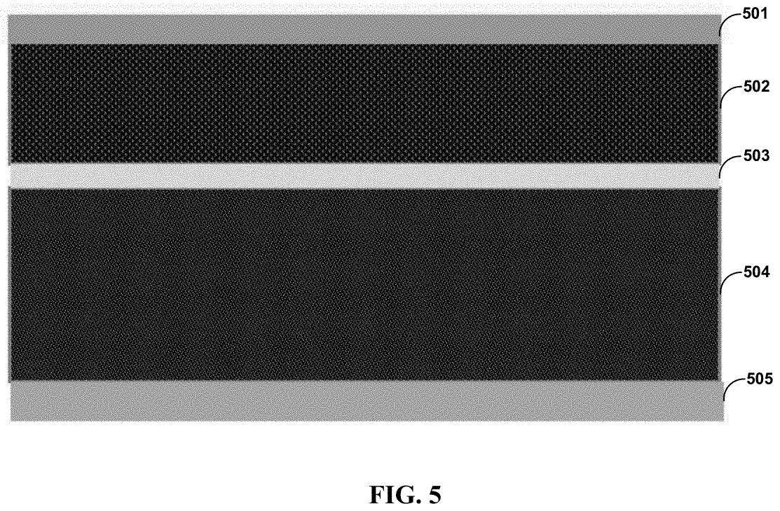

FIG. 5 shows an exemplary schematic of a cross-sectional view of a single-layer cell prepared in accordance with embodiments of the present disclosure. The exemplary single-layer cell is formed from a carbonaceous (e.g., graphite) based PME-anode and NMC-based PME-cathode. The exemplary single-layer cell includes a positive current collector layer 505 adjacent to a PME-cathode layer 504. Non-limiting examples of positive current collectors include aluminum or carbon coated aluminum. The PME-cathode layer 504 is then interposed between the current collector 505 and a solid PME layer 503, where the solid PME layer 503 is then interposed between the PME-cathode layer 504 and a PME-anode layer 502. Lastly, PME-anode layer 502 is adjacent to negative current collector 501 and interposed between the solid PME layer 503 and the negative current collector 501. Non-limiting examples of negative current collectors include copper, nickel, carbon coated copper, or carbon coated nickel. This method of using only two layers (e.g., PME-anode and PME-cathode) without the need for liquid electrolyte injection differentiates the single-layer cell of the present disclosure from the conventional LiBs where three layers (e.g., cathode, separator, and anode) are put together followed by injection of liquid electrolyte for completion.

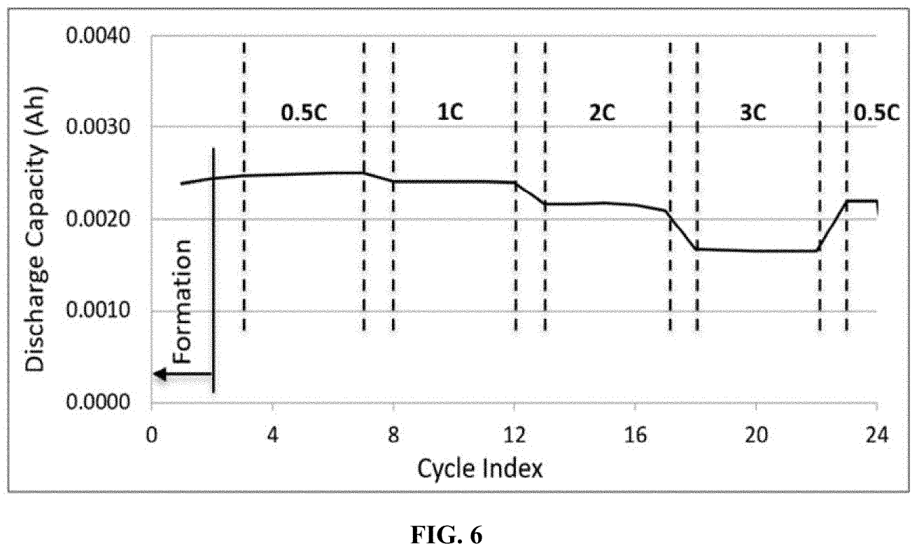

FIG. 6 shows an exemplary rate of performance data of a single-layer cell prepared according to the intermittent laminating process described above and shown in FIG. 5. To determine the rate performance, the cell was charged with CCCV at a C/2 CC rate and discharged at different C-rates from C/2 to 3 C. The results show that the PME based cells are capable of releasing energy at 3 C rates to the tune of 70% of a C/2 rate which is required for most power applications in the CE and EV markets.

V. Process of Forming Single-Layer Cells with a Composite Cathode and an Li Metal Anode

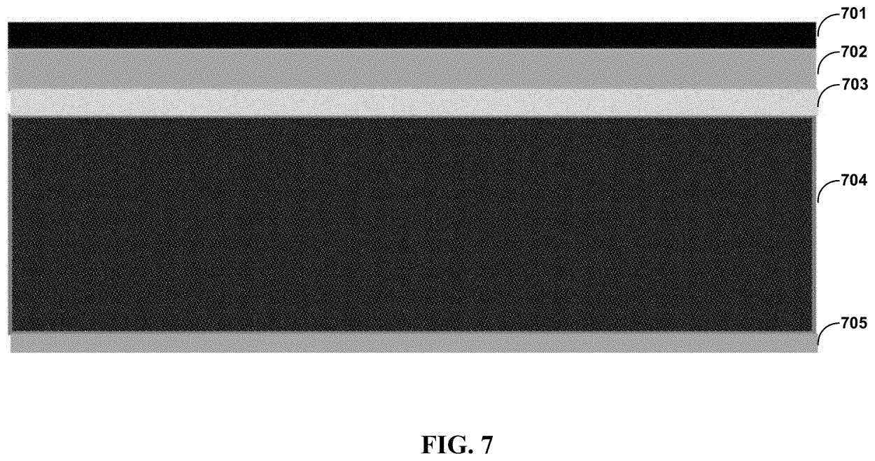

The present disclosure provides methods of making single-layer cells comprising at least one metal anode, at least one PME-cathode, and at least one PME layer sandwiched by the metal anode and PME-cathode. The process for forming the single-layer cells with a composite cathode and Li metal anode is similar to the process described above with respect to the single-layer cell comprising a PME-anode and PME-cathode. However, the PME-anode is replaced with an Li metal layer to form a single-layer cell with a composite cathode (e.g., PME-cathode) and an Li metal anode as shown in FIG. 7.

FIG. 7 shows an exemplary schematic of a cross-sectional view of a single-layer cell comprising a PME-cathode and an Li metal anode in accordance with embodiments of the present disclosure. The exemplary single-layer cell is formed from an NMC-based PME-cathode and an Li metal anode. The exemplary single-layer cell includes a positive current collector layer 705 adjacent to PME-cathode layer 704. Non-limiting examples of positive current collectors include aluminum or carbon coated aluminum. The PME-cathode layer 704 is then interposed between the positive current collector layer 705 and a solid PME layer 703, where the solid PME layer 703 is then interposed between the PME-cathode layer 704 and a metal anode 702. Lastly, the metal anode 702 is adjacent to negative current collector 701 and interposed between the solid PME layer 703 and the negative current collector 701. Non-limiting examples of negative current collectors include copper, nickel, carbon coated copper, or carbon coated nickel. In some embodiments, the single-layer cell comprising the composite cathode and Li metal anode does not include the negative collector 701.

In some embodiments, the single-layer cells comprising at least one metal anode, at least one PME-cathode, and at least one PME layer sandwiched by the metal anode and PME-cathode are formed by laminating each layer. In some embodiments, laminating one layer to another layer is carried out at a temperature of about 50° C. to about 130° C. by placing the layers between two heated hotplates. In some embodiments, laminating one layer to another layer includes intermittent laminating where the heat is removed and reapplied several times. Intermittent laminating can provide strong contact between the layers with minimal interface resistance. In some embodiments, the intermittent laminating includes heating the layers for about 1 minute to about 60 minutes and then removing the heat from about 1 minute to about 60 minutes. In some embodiments, the heat is reapplied about 1 time to about 20 times during the laminating process. In some embodiments, the single-layer cells can have capacities from as low as a few milli-Ampere-hours (mAh) to Ampere-hours (Ah).

In some embodiments, the PME-cathode and/or PME layer are in a solvated state prior to the lamination step. In some embodiments, the PME-cathode and/or PME layer in the solvated state comprise solvent in an amount of about 5% to about 20%, by weight, of a total weight of the PME-cathode and/or PME layer. For example, about 5%, about 6%, about 7%, about 8%, about 9%, about 10%, about 11%, about 12%, about 13%, about 14%, about 15%, about 16%, about 17%, about 18%, about 19%, or about 20%, by weight, of a total weight of the PME-cathode and/or PME layer. By remaining in a solvated state, the PME-cathode and/or PME layer can be used directly in processes for preparing battery cells comprising the PME-cathode and/or PME layer without an additional activation/re-wetting step. In some embodiments, the process does not require an additional activation/re-wetting step of the PME-cathode and/or PME layer.

### Methods of Making Battery Cells by Roll-to-Roll Processing

I. Single-Layer Cells with Composite Anode and Cathode

The present disclosure provides a continuous roll-to-roll process for preparing single-layer battery cells with a composite anode and cathode similar to that shown in FIG. 5. The roll-to-roll process described herein is a continuous process where the anode and the cathode are prepared simultaneously and brought together to form the battery cell. This contrasts with conventional roll-to-roll processes where the anode and cathode are made separately and stored in a roll (e.g., on a reel). To assemble the battery cell, the anode and cathode are removed from the roll and combined, where the combined anode and cathode are once again rolled (e.g., on a reel) together until final assembly of the battery cell. In the conventional methods, the front end of the process (e.g., forming the electrode) is separated from the back end of the process (e.g., forming the cell). The roll-to-roll process described herein combines the front end and backend processes into one continuous process where the anode and cathode are formed simultaneously and while the battery cell is formed.

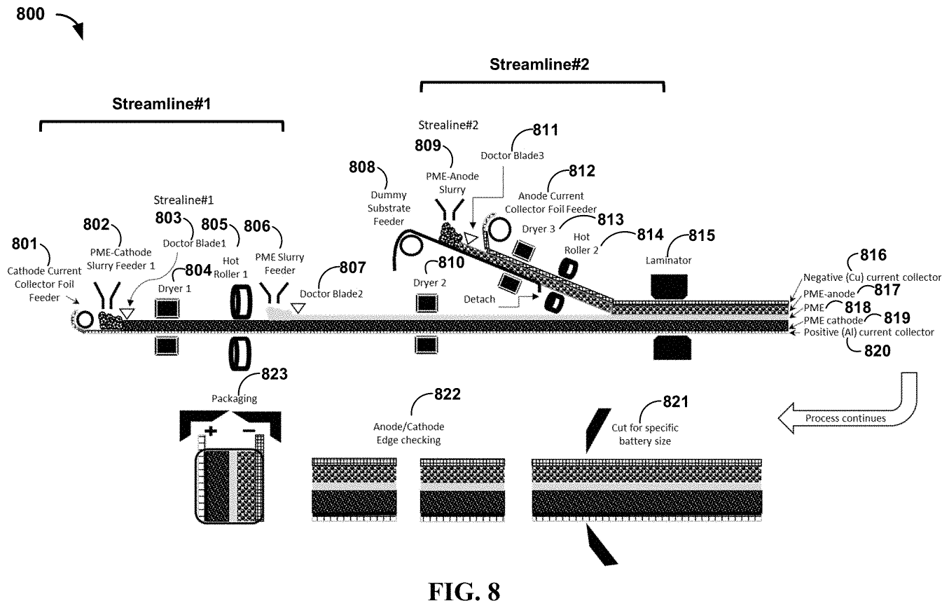

FIG. 8 is a diagram illustrating an example embodiment of a roll-to-roll process 800 for preparing single-layer cells with a composite anode (e.g., PME-anode) and composite cathode (e.g., PME-cathode) in accordance with embodiments of the present disclosure. The process 800 includes two processes designated as streamline #1 and streamline #2. Streamline #1 demonstrates the process of preparing the PME-cathode whereas streamline #2 describes the process of preparing the PME-anode. The streamline processes #1 and #2 can occur simultaneously so as to enable the continuous formation of a single-layer battery cell. This contrasts with processes that require first forming the anode and then forming the cathode, prior to bringing the two components together. The process 800 includes forming the anode and cathode components simultaneously so as to increase the efficiency of the overall roll-to-roll process of preparing single-layer battery cells.

In the process 800, the PME solution is made according to process 100 at step 103, and the PME-cathode slurry and PME-anode slurry are made according to process 300 at step 303 described above. However, the process 800 includes preparing large volume solutions for a continuous coating process to make the single-layer cells via a roll-to-roll processing technique.

The process 800 can begin with “Streamline #1” with depositing a PME-cathode slurry through a PME-cathode slurry feeder 802 onto a positive current collector, where the positive current collector is fed from a continuously rolling cathode current collector foil feeder 801. In some embodiments, the positive current collector is aluminum or carbon coated aluminum. In some embodiments, PME-cathode slurry feeder 802 can include a flush gate valve with adjustable blade gap. In some embodiments, PME-cathode slurry feeder 802 does not include a flush gate valve with adjustable blade gap. The adjustable blade gap allows for areal coating of the positive current collector substrate to make different battery sizes for different capacities. The coating blade gap is adjustable to facilitate different PME-cathode thicknesses in the range of about 10 microns to about 80 microns. The process 800 can include coating the positive current collector with the PME-cathode slurry using a doctor blade 803.

After the positive current collector is coated with the PME-cathode slurry, the process 800 includes drying the PME-cathode coated current collector by passing it through dryer 804. In some embodiments, the PME-cathode coated current collector is dried at a temperature of about 60° C. to about 100° C. with air speed of about 5 m/sec to about 20 m/sec and a delay of about 1 minute to about 5 minutes inside the furnace chamber of the dryer 804. In some embodiments, the PME-cathode layer is not fully dried and remains in a solvated state. In some embodiments, the PME-cathode layer in the solvated state comprises solvent in an amount of about 5% to about 20%, by weight, of a total weight of the PME-cathode layer. For example, about 5%, about 6%, about 7%, about 8%, about 9%, about 10%, about 11%, about 12%, about 13%, about 14%, about 15%, about 16%, about 17%, about 18%, about 19%, or about 20%, by weight, of a total weight of the PME-cathode layer. In some embodiments, the process does not require an additional step of activation/re-wetting the PME-cathode layer.

The process 800 then includes calendering the PME-cathode coated current collector using a hot roller 805. In some embodiments, the hot roller 805 is set to a temperature between about 50° C. to 120° C. In some embodiments, the hot rolled PME-cathode has a porosity of about 10% to about 40%, by volume, of the total PME-cathode after PME-cathode has been calendered.

The process 800 then continues where the hot rolled PME-cathode, which still has the porosity in the range of 10% to 40%, is coated with a thin layer of PME slurry fed through a PME slurry feeder 806. The PME slurry covers the entire coated PME-cathode area and can include an additional margin that extends in a range of 0.5 mm to 2 mm relative to the dimensions of the PME-cathode. In some embodiments, the PME slurry feed has a viscosity in the range of about 1,000 cP to about 25,000 cP. In some embodiments, the PME slurry has an adjustable blade gap of about 50 microns to about 250 microns. The adjustable blade gap enables the formation of a non-porous PME layer that can infuse into the pores of the PME-cathode structure. The process 800 can include coating the PME-cathode with the PME slurry using a doctor blade 807. The process 800 then continues where the PME-cathode structure, now coated with a PME layer, is placed in a dryer 810. In some embodiments, the PME-cathode structure coated with the PME layer is dried in an oven at about 50° C. to about 120° C. for about 0.5 hours to about 12 hours. In some embodiments, the PME layer is not fully dried and remains in a solvated state. In some embodiments, the PME layer in the solvated state comprises solvent in an amount of about 5% to about 20%, by weight, of a total weight of the PME-cathode layer. For example, about 5%, about 6%, about 7%, about 8%, about 9%, about 10%, about 11%, about 12%, about 13%, about 14%, about 15%, about 16%, about 17%, about 18%, about 19%, or about 20%, by weight, of a total weight of the PME layer. In some embodiments, the process does not require the additional step of activation/re-wetting the PME layer.

The process 800 can also begin with streamline #2 with depositing a PME-anode slurry through a PME-anode slurry feeder 809 onto a dummy substrate, where the dummy substrate is fed from a continuously rolling dummy substrate feeder 808. Non-limiting examples of suitable materials for the dummy substrate include Mylar, Kapton, Teflon, or any other detachable sheet. The dummy substrate serves as a temporary substrate for the PME-anode layer, providing a template for the formation of the PME-anode layer. The process 800 can include coating the dummy substrate with the PME-anode slurry using a doctor blade 811.

The process 800 can continue where a negative current collector from a continuously rolling anode current collected foil feeder 812 is introduced on top of the wet PME-anode layer. This step occurs before the PME-anode layer has completely dried. The wet PME-anode layer allows for adequate bonding between the negative current collector and the PME-anode layer. Non-limiting examples of suitable materials for the negative current collector include copper, nickel, carbon coated copper, or carbon coated nickel. The process 800 then continues where the PME-anode layer, sandwiched between the dummy substrate and the negative current collector is placed in dryer 813. In some embodiments, the PME-anode layer, sandwiched between the dummy substrate and the negative current collector, is dried in an oven at about 50° C. to about 120° C. for about 0.5 hours to about 12 hours. In some embodiments, the PME-anode layer is not fully dried and remains in a solvated state. In some embodiments, the PME-anode layer in the solvated state comprises solvent in an amount of about 5% to about 20%, by weight, of a total weight of the PME-anode layer. For example, about 5%, about 6%, about 7%, about 8%, about 9%, about 10%, about 11%, about 12%, about 13%, about 14%, about 15%, about 16%, about 17%, about 18%, about 19%, or about 20%, by weight, of a total weight of the PME-anode layer. In some embodiments, the process does not require an additional step of activation/re-wetting the PME-anode layer.

After drying, the dummy substrate is removed from the PME-anode layer. The process 800 then includes calendering the PME-anode connected to the negative current collector using a hot roller 814. In some embodiments, the hot roller 814 is set to a temperature between about 50° C. to about 120° C. In some embodiments, the hot rolled PME-anode has a porosity of about 10% to about 40%, by volume, of the total PME-anode after PME-cathode has been calendered.

The process 800 can continue where the PME-cathode coated with a PME layer and bound to a positive current collector is combined with the PME-anode bound to a negative current collector. The process 800, including the coating steps, allows for the PME-anode and the PME-cathode coated with a PME layer to be combined without collapsing the structures of the PME-anode and PME-cathode. Before the PME-cathode and PME-anode are combined, a blade gap for a specific PME-anode thickness and surface area is chosen considering the PME-cathode size, N/P ratio for specific battery design, and the specific capacity of the active materials. In some embodiments, to prevent potentially short circuiting the cell, the PME-anode layer is wider than the corresponding PME-cathode but has a similar dimension to that of the PME layer coating the PME-cathode, wherein the PME layer is between about 0.5 mm to about 2 mm wider than the PME-cathode layer. In some embodiments, the length of the substrates is adjustable. In some embodiments, the amount of time required to dry the coated substrates varies. Adjusting the length of the substrates and the time required for drying can prevent sticking between the rolls and dummy substrate by ensuring that the substrates remain in a wet state while also ensuring that the substrates are not too dry so as to prevent adequate bonding of the PME-anode to the negative current collector and bonding PME layer to the PME-cathode.

The process 800 then continues where the PME-cathode coming from continuous streamline #1 and the PME-anode coming from continuous streamline #2 are combined and laminated by laminator 815. In some embodiments, the lamination is carried out at a scheduled time and at a temperature between about 50° C. to about 130° C. for about 1 minute to about 60 minutes between two lamination plates. The lamination step not only ensures good contact between the PME-cathode and PME-anode layers with the sandwiched PME layer in between to serve as a solid electrolyte separator, but also that the electrodes are sufficiently densified with the PME filling the pores in the electrodes structure. Following the lamination step, a battery cell comprising a first layer including the negative current collector 816, a second layer including the PME-anode 817, a third layer including the PME layer 818, a fourth layer including the PME-cathode 819, and a fifth layer including the positive current collector 820 is formed.

The process 800 then continues to the assembly of the battery cell. The assembly can include a singulation, functional testing, and/or final packaging steps. The process 800 can continue to the singulation stage 821, where the battery cell is cut into different sizes to make different formats of solid-state LiBs. The process 800 can then continue to the functional testing stage 822 where the singulated cells are tested for functionality. Functionality tests can include checking the edges of the PME-anode and PME-cathode, DC resistance, no short circuiting, ACI, and OCV. After the functionality of the singulated cells is confirmed, the cells are transferred to the packaging stage 823 where tabs are welded onto the current collectors and the cells are packaged into a container to complete the full battery assembly.

II. Single-Layer Cells with Composite Cathode and Li Metal Anode

The present disclosure provides a process for preparing single-layer battery cells with a composite cathode and Li metal anode having a structure exemplified in FIG. 7 via roll-to-roll manufacturing process. In some embodiments, the roll-to-roll manufacturing process includes replacing anode slurry feeder 809 in FIG. 8 with lithium metal foil. In some embodiments, the PME-cathode coated with a PME layer is laminated with the lithium anode layer to form the battery cell. In some embodiments, the battery cell does not have a negative current collector adjacent to and in electrical communication to the lithium anode. In some embodiments, the battery cell includes a negative current collector adjacent to and in electrical communication to the lithium anode.

In embodiments, the dimensions of the lithium anode are less than the PME layer coated on top of the PME-cathode. In some embodiments, the dimensions of the lithium anode are the same as the PME-cathode. In some embodiments, the lithium anode has dimensions less than the PME layer coated on top of the PME-cathode but the same dimensions as the PME-cathode. In some embodiments, when the lithium anode has dimensions less than the PME layer coated on top of the PME-cathode but the same dimensions as the PME-cathode, the lithium anode is prevented from contacting the positive current collector, which could short circuit the cell.

In some embodiments, the single-layer cells comprising a composite cathode and Li metal anode are laminated, singulated, tested, and packaged according to process 800.

III. Multi-Layer Structure for PME Cells with Either Composite Graphite or Lithium Metal Anode

The present disclosure provides a continuous roll-to-roll process for preparing single-layer battery cells with a composite anode and cathode. In some embodiments, the multi-layer battery cells comprise two or more electrodes layers with a single common positive (e.g., Al) or negative (e.g., Cu) current collector.

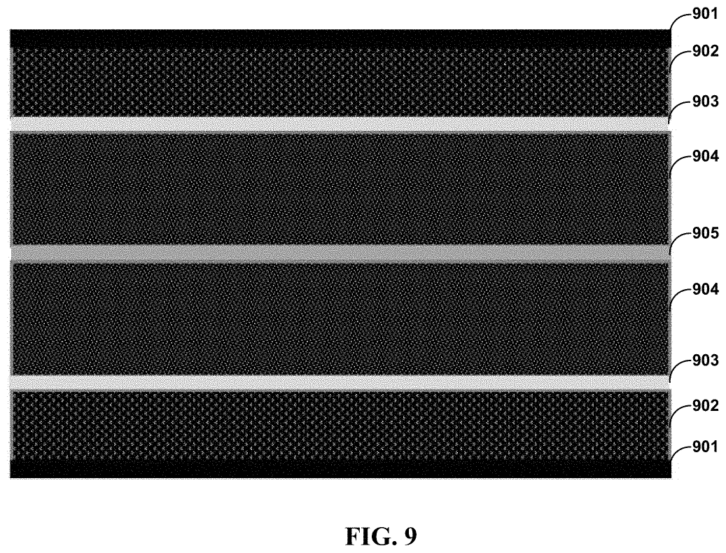

In some embodiments, the multi-layer comprises a common positive current collector, where the multi-layer cell comprises, sequentially, a first negative current collector layer, a first PME-anode layer, a first solid PME layer, a centrally located common positive current collector, a second solid PME layer, a second PME-anode layer, and a second negative current collector layer. FIG. 9 shows an exemplary schematic of a multi-layer cell comprising PME-cathodes, PME-anodes, and a common positive current collector in accordance with embodiments of the present disclosure. The exemplary multi-layer cell is formed from a graphite anode and a single common positive current collector double-sided cathode. The exemplary multi-layer cell includes a negative current collector layer 901 adjacent to a PME-anode layer 902. The PME-anode layer 902 is interposed between the negative current collector layer 901 and a solid PME layer 903, where the solid PME layer 903 is then interposed between the PME-anode layer and a PME-cathode layer 904. The PME-cathode layer 904 is then adjacent to a shared positive current collector 905 and interposed between the solid PME layer 903 and the positive current collector 905. These layers form the first half of the multi-layer cell where each of the layers are then repeated, in the same order, on the other side of the shared positive current collector 905 as shown in FIG. 9.

In some embodiments, the multi-layer cell comprises a common negative current collector, where the multi-layer cell comprises, sequentially, a first positive current collector layer, a first PME-cathode layer, a first solid PME layer, a centrally located common negative current collector, a second solid PME layer, a second PME-cathode layer, and a second positive current collector layer.

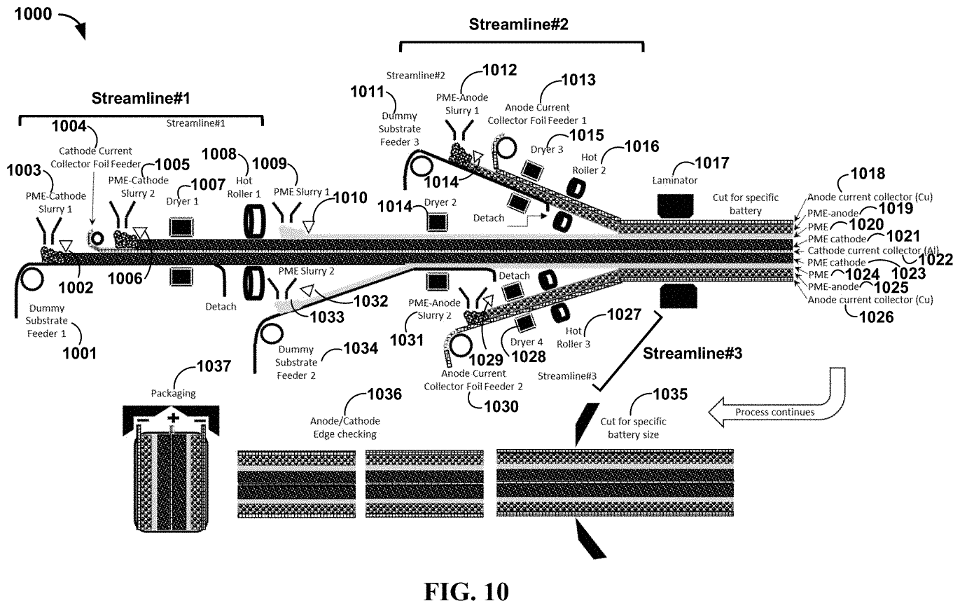

FIG. 10 is a diagram illustrating an example embodiment of a roll-to-roll process 1000 for preparing multi-layer cells comprising a single common positive current collector in accordance with embodiments of the present disclosure. The process 1000 includes three processes designated as streamline #1, streamline #2, and streamline #3. Streamline #1 demonstrates the process of preparing the PME-cathode and streamline #2 describes the process of preparing the PME-anode. The streamline processes #1, #2, and #3 can occur simultaneously so as to enable the continuous formation of a multi-layer battery cell.

In the process 1000, the PME solution is made according to process 100 at step 103 and the PME-cathode solutions and PME-anode solution are made according to process 300 at step 303 described above. However, the process 1000 includes preparing large volume solutions for a continuous coating process to make the multi-layer cells via a roll-to-roll processing technique.

The process 1000 can begin with “Streamline #1” with depositing a PME-cathode slurry through a PME-cathode slurry feeder 1003 onto a dummy substrate, where the substrate is fed from a continuously rolling dummy substrate feeder 1001. In some embodiments, the dummy substrate is Mylar, Kapton, Teflon, or any other detachable sheet. In some embodiments, PME-cathode slurry feeder 1003 can include a flush gate valve with an adjustable blade gap. In some embodiments, PME-cathode slurry feeder 1003 does not include a flush gate valve with adjustable blade gap. The adjustable blade gap allows for areal coating of the substrate to make different battery sizes for different capacities. The coating blade gap is adjustable to facilitate different PME-cathode thicknesses in the range of about 10 microns to 80 microns. The process 1000 can include coating the dummy substrate with the PME-cathode slurry using a doctor blade 1002.

The process 1000 then continues where a positive current collector is unwound from a positive current collector foil feeder 1004 and placed directly onto the PME-cathode layer. The process 1000 can then continue where a second layer of a PME-cathode is deposited onto the other side of the positive current collector (i.e., the side not adjacent to the first PME-cathode) through a second PME-cathode slurry feeder 1005. The process 1000 can include coating a second PME-cathode slurry onto the positive current collector using a doctor blade 1006. This step results in a positive current collector coated, on both sides, with a PME-cathode layer.

The process 1000 then continues where the positive current collector coated, on both sides, with a PME-cathode layer is fed through a dryer 1007 for drying. In some embodiments, the PME-cathode coated current collector is dried at a temperature of about 60° C. to 100° C. with an air speed of about 5 m/sec to about 20 m/sec and a delay of about 1 minute to about 5 minutes inside the furnace chamber of the dryer 1007. In some embodiments, the PME-cathode layer is not fully dried and remains in a solvated state. In some embodiments, the PME-cathode layer in the solvated state comprises solvent in an amount of about 5% to about 20%, by weight, of a total weight of the PME-cathode layer. For example, about 5%, about 6%, about 7%, about 8%, about 9%, about 10%, about 11%, about 12%, about 13%, about 14%, about 15%, about 16%, about 17%, about 18%, about 19%, or about 20%, by weight, of a total weight of the PME-cathode layer. In some embodiments, the process does not require an additional step of activation/re-wetting the PME-cathode layer.

After the drying process, the PME-cathode layers will be bound tightly to the opposite sides of the common positive current collector. The dummy substrate bound to the bottom of the first PME-cathode layer is then detached before the process 1000 proceeds to the next steps. The process 1000 then includes calendering the symmetric PME-cathode coating on both sides of the common positive current collector using hot roller 1008. In some embodiments, the hot roller 1008 is set to a temperature between about 50° C. to 120° C. In some embodiments, the temperature of the dryer 1007 as well as the length and speed of the streamline flow between the dryer 1007 and hot roller 1008 can be adjusted to prevent sticking to the hot roller 1008. In some embodiments, the hot rolled PME-cathodes have a porosity of about 10% to about 40%, by volume, of the total PME-cathode after PME-cathode has been calendered.

The process 1000 can continue where a PME layer is deposited onto a first side of the symmetric PME-cathode coating the common positive current collector through a PME slurry feeder 1009. The process 1000 can include coating the first side of the PME-cathode with the PME slurry using a doctor blade 1010. The PME slurry covers the entire coated PME-cathode area and can include an additional margin that extends in a range of 0.5 mm to 2 mm relative to the dimensions of the PME-cathode. Simultaneously, the process 100 includes depositing another PME layer, with the same coating margin, through a PME slurry feeder 1033 onto a second dummy substrate feed, where the second dummy substrate is fed from a continuously rolling dummy substrate feeder 1034. The process 1000 can include coating the second dummy substrate with the PME slurry using a doctor blade 1032. The PME layer deposited onto the second dummy substrate is then pressed onto the second side of the symmetric PME-cathode coating the common positive current collector. When the PME layer is pressed onto the second side of the PME-cathode, both layers are still wet to allow for adequate bonding between the PME layer and the PME-cathode.

The process 1000 then continues where the two PME layers coated on both sides of the PME-cathode are subjected to drying at dryer 1014. In some embodiments, two PME layers coated on both sides of the PME-cathode are dried at a temperature of about 60° C. to 100° C. with an air speed of about 5 m/sec to about 20 m/sec and a delay of about 1 minute to about 5 minutes inside the furnace chamber of the dryer 1014. In some embodiments, the two PME layers and/or PME-cathode layer are not fully dried and remain in a solvated state. In some embodiments, the two PME layers and/or PME-cathode layer in the solvated state comprise solvent in an amount of about 5% to about 20%, by weight, of a total weight of the two PME layers and/or PME-cathode layer. For example, about 5%, about 6%, about 7%, about 8%, about 9%, about 10%, about 11%, about 12%, about 13%, about 14%, about 15%, about 16%, about 17%, about 18%, about 19%, or about 20%, by weight, of a total weight of the two PME layers and/or PME-cathode layer. In some embodiments, the process does not require the additional steps of activation/re-wetting the two PME layers and/or PME-cathode layer. The second dummy substrate at the bottom of the PME layer is then detached. At this point in the process 1000, the steps of streamline #1 are complete.

The process 1000 can also begin with streamline #2 with depositing a PME-anode slurry through a PME-anode slurry feeder 1012 onto a dummy substrate, where the dummy substrate is fed from a continuously rolling dummy substrate feeder 1011. The process 1000 can include coating the dummy substrate with the PME-anode slurry using a doctor blade 1014.

The process 1000 can continue where before the PME-anode layer dries, a negative current collector from a continuously rolling anode current collected foil feeder 1013 is introduced on top of the wet PME-anode layer. The wet PME-anode layer allows for adequate bonding between the negative current collector and the PME-anode layer. The process 1000 then continues where the PME-anode layer, sandwiched between the dummy substrate and the negative current collector, is placed in a dryer 1015. In some embodiments, the PME-anode layer, sandwiched between the dummy substrate and the negative current collector is dried in an oven at about 50° C. to about 120° C. for about 0.5 hours to about 12 hours. After drying, the dummy substrate is then removed from the PME-anode layer. In some embodiments, the PME-anode layer is not fully dried and remain in a solvated state. In some embodiments, the PME-anode layer in the solvated state comprises solvent in an amount of about 5% to about 20%, by weight, of a total weight of the PME-anode layer. For example, about 5%, about 6%, about 7%, about 8%, about 9%, about 10%, about 11%, about 12%, about 13%, about 14%, about 15%, about 16%, about 17%, about 18%, about 19%, or about 20%, by weight, of a total weight of the PME-anode layer. In some embodiments, the process does not require the additional steps of activation/re-wetting the PME-anode layer.

The process 1000 then includes calendering the PME-anode connected to the negative current collector using a hot roller 1016. In some embodiments, the hot roller 1016 is set to a temperature between about 50° C. to about 120° C. In some embodiments, the hot rolled PME-anode has a porosity of about 10% to about 40%, by volume, of the total volume of the calendered PME-anode. In some embodiments, the coating dimensions of the PME-anode layer are the same as the PME layers but smaller than the PME-cathode layers to prevent shorting.

The process 1000 can also begin with streamline #3 with depositing a PME-anode slurry through a PME-anode slurry feeder 1031 onto an anode current collector, where the anode current collector is fed from a continuously rolling anode current collector foil feeder 1030. The process 1000 can include coating the negative current collector with the PME-anode slurry using a doctor blade 1029. The process 1000 then continues where the PME-anode layer on top of the negative current collector is placed in a dryer 1028. In some embodiments, the PME-anode layer on top of the negative current collector is dried in an oven at about 50° C. to about 120° C. for about 0.5 hours to about 12 hours. In some embodiments, the PME-anode layer is not fully dried and remains in a solvated state. In some embodiments, the PME-anode layer in the solvated state comprises solvent in an amount of about 5% to about 20%, by weight, of a total weight of the PME-anode layer. For example, about 5%, about 6%, about 7%, about 8%, about 9%, about 10%, about 11%, about 12%, about 13%, about 14%, about 15%, about 16%, about 17%, about 18%, about 19%, or about 20%, by weight, of a total weight of the PME-anode layer. In some embodiments, the process does not require the additional steps of activation/re-wetting the PME-anode layer.

The process 1000 then includes calendering the PME-anode connected to the negative current collector using a hot roller 1027. In some embodiments, the hot roller 1027 is set to a temperature between about 50° C. to about 120° C. In some embodiments, the hot rolled PME-anode has a porosity of about 10% to about 40%, by volume, of the total volume of the calendered PME-anode. In some embodiments, the coating dimensions of the PME-anode layer are the same as the PME layers but smaller than PME-cathode layers to prevent shorting.

In an alternative embodiment, the streamline #3 does not include using a detachable dummy substrate feeder 1034 for applying the PME slurry; instead, the slurry is applied directly on top of the PME-anode having been fed through dryer 1028 and hot roller 1027. The PME-anode coated with the PME layer is then passed through another set of dryers (not shown in FIG. 10) before streamline #3 comes together with streamline #1 and streamline #2 prior to lamination. In some embodiments, the PME-anode layer is not fully dried and remains in a solvated state. In some embodiments, the PME-anode layer in the solvated state comprises solvent in an amount of about 5% to about 20%, by weight, of a total weight of the PME-anode layer. For example, about 5%, about 6%, about 7%, about 8%, about 9%, about 10%, about 11%, about 12%, about 13%, about 14%, about 15%, about 16%, about 17%, about 18%, about 19%, or about 20%, by weight, of a total weight of the PME-anode layer. In some embodiments, the process does not require an additional step of activation/re-wetting the PME-anode layer.

The process 1000 then continues where the PME-cathode coming from continuous streamline #1 and the PME-anodes coming from continuous streamline #2 and streamline #3 are combined and laminated by laminator 1017. In some embodiments, the lamination is carried out at a scheduled time and at a temperature between about 50° C. to about 130° C. for about 1 minute to about 60 minutes between two lamination plates. During the lamination step, some remaining pores in the PME-cathode and PME-anode are also filled with PME, and this provides a well distributed homogeneous multilayer with contiguous structure of PME-anode, PME overcoat, and PME-cathode. The lamination step not only ensures good contact between each of the layers, but also ensures that the electrodes are sufficiently densified with the PME filling the pores in the electrodes structure. Following the lamination step, a battery cell comprising a first layer including the negative current collector 1018, a second layer including the PME-anode 1019, a third layer including the PME layer 1020, a fourth layer including the PME-cathode 1021, a fifth layer including the shared positive current collector 1022, a sixth layer including a PME-cathode 1023, a seventh layer including a PME layer 1024, an eighth layer including a PME-anode 1025, and lastly, a ninth layer including a negative current collector 1026 is formed.

The process 1000 then continues to the assembly of the battery cell. The assembly can include a singulation, functional testing, and/or final packaging steps. The process 1000 can continue to the singulation stage 1035, where the battery cell is cut into different sizes to make different formats of solid-state LiBs. The process 1000 can then continue to the functional testing stage 1037 where the singulated cells are tested for functionality. Functionality tests can include checking the edges of the anode and cathode, DC resistance, no short circuiting, ACI, and OCV. After the functionality of the singulated cells is confirmed, the cells are transferred to the packaging stage 1037 where tabs are welded onto the current collectors and the cells are packaged into a container to complete the full battery assembly.

IV. Multi-Layer Cells with Composite Cathode and Li Metal Anode

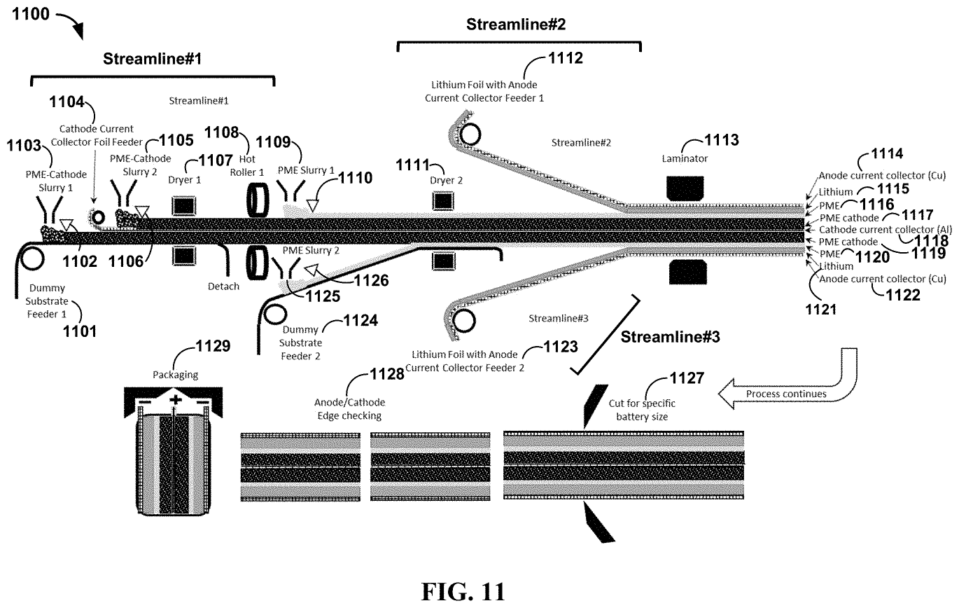

The present disclosure provides a continuous roll-to-roll process for preparing multi-layer battery cells with a lithium metal anode. FIG. 11 is a diagram illustrating an example embodiment of a roll-to-roll process 1100 for preparing multi-layer cells comprising PME-cathodes, Li metal anodes, and a common positive current collector in accordance with embodiments of the present disclosure. The process 1000 includes three processes designated as streamline #1, streamline #2, and streamline #3. Streamline #1 demonstrates the process of preparing the PME-cathode, and streamline #2 and streamline #3 describe the metal anode. The streamline processes #1, #2, and #3 can occur simultaneously so as to enable the continuous formation of a multi-layer battery cell.

The streamline #1 of process 1100 is the same as that described for streamline #1 of process 1000. The process 1100 can begin with “Streamline #1” with depositing a PME-cathode slurry through a PME-cathode slurry feeder 1103 onto a dummy substrate, where the substrate is fed from a continuously rolling dummy substrate feeder 1101. In some embodiments, PME-cathode slurry feeder 1103 can include a flush gate valve with an adjustable blade gap. In some embodiments, PME-cathode slurry feeder 1103 does not include a flush gate valve with adjustable blade gap. The adjustable blade gap allows for areal coating of the substrate to make different battery sizes for different capacities. The coating blade gap is adjustable to facilitate different PME-cathode thicknesses in the range of about 10 microns to 80 microns. The process 1100 can include coating the dummy substrate with the PME-cathode slurry using a doctor blade 1102.

The process 1000 then continues where a positive current collector is unwound from a positive current collector foil feeder 1104 and placed directly onto the PME-cathode layer. The process 1000 can then continue where a second layer of a PME-cathode is deposited onto the other side of the positive current collector (i.e., the side not adjacent to the first PME-cathode) through a second PME-cathode slurry feeder 1105. The process 1000 can include coating the second PME-cathode slurry onto the positive current collector using a doctor blade 1106. This step results in a positive current collector coated, on both sides, with a PME-cathode layer.

The process 1000 then continues where the positive current collector coated, on both sides, with a PME-cathode layer is fed through a dryer 1107 for drying. In some embodiments, the PME-cathode coated current collector is dried at a temperature of about 60° C. to 100° C. with an air speed of about 5 m/sec to about 20 m/sec and a delay of about 1 minute to about 5 minutes inside the furnace chamber of the dryer 1107. In some embodiments, the PME-cathode layers are not fully dried and remain in a solvated state. In some embodiments, the PME-cathode layers in the solvated state comprise solvent in an amount of about 5% to about 20%, by weight, of a total weight of the PME-cathode layers. For example, about 5%, about 6%, about 7%, about 8%, about 9%, about 10%, about 11%, about 12%, about 13%, about 14%, about 15%, about 16%, about 17%, about 18%, about 19%, or about 20%, by weight, of a total weight of the PME-cathode layers. In some embodiments, the process does not require an additional step of activation/re-wetting the PME-cathode layers. After the drying process, the PME-cathode layers will be bound tightly to the opposite sides of the common positive current collector. The dummy substrate bound to the bottom of the first PME-cathode layer is then detached before the process 1100 proceeds to the next steps. The process 1100 then includes calendering the symmetric PME-cathode coating on both sides of the common positive current collector using hot roller 1108. In some embodiments, the hot roller 1108 is set to a temperature between about 50° C. to about 120° C. In some embodiments, the temperature of the dryer 1107 as well as the length and speed of the streamline flow between the dryer 1107 and hot roller 1108 can be adjusted to prevent sticking to the hot roller 1108. In some embodiments, the hot rolled PME-cathodes have a porosity of about 10% to about 40%, by volume, of the total PME-cathode after PME-cathode has been calendered.

The process 1100 can continue where a PME layer is deposited onto a first side of the symmetric PME-cathode coating the common positive current collector through a PME slurry feeder 1109. The process 1100 can include coating the first side of the PME-cathode with the PME slurry using a doctor blade 1110. The PME slurry covers the entire coated PME-cathode area and can include an additional margin that extends in a range of 0.5 mm to 2 mm relative to the dimensions of the PME-cathode. Simultaneously, the process 1100 includes depositing another PME layer, with the same coating margin, through a PME slurry feeder 1125 onto a second dummy substrate, where the second dummy substrate is fed from a continuously rolling dummy substrate feeder 1124. The process 1100 can include coating the second dummy substrate with the PME slurry using a doctor blade 1126. The PME layer deposited onto the second dummy substrate is then pressed onto the second side of the symmetric PME-cathode coating the common positive current collector. When the PME layer is pressed onto the second side of the PME-cathode, both layers are still wet to allow for adequate bonding between the PME layer and the PME-cathode.

The process 1100 then continues where the two PME layers coated on both sides of the PME-cathode are subjected to drying at dryer 1111. In some embodiments, two PME layers coated on both sides of the PME-cathode are dried at a temperature of about 60° C. to 100° C. with an air speed of about 5 m/sec to about 20 m/sec and a delay of about 1 minute to about 5 minutes inside the furnace chamber of the dryer 111. In some embodiments, the PME-cathode layers are not fully dried and remain in a solvated state. In some embodiments, the PME-cathode layers in the solvated state comprise solvent in an amount of about 5% to about 20%, by weight, of a total weight of the PME-cathode layers. For example, about 5%, about 6%, about 7%, about 8%, about 9%, about 10%, about 11%, about 12%, about 13%, about 14%, about 15%, about 16%, about 17%, about 18%, about 19%, or about 20%, by weight, of a total weight of the PME-cathode layers. In some embodiments, the process does not require an additional step of activation/re-wetting the PME-cathode layers. The second dummy substrate at the bottom of the PME layer is then detached. At this point in the process 1100, the steps of streamline #1 are complete.

The process 1100 can also begin with streamline #2 and streamline #3 where the PME-anode coating streamline #2 and streamline #3 of process 1000 are replaced with rolls of lithium foil. The process 1100 includes feeding a lithium foil bound to a negative current collector through feeder 1112 and feeder 1123 to combine with the PME-cathode of streamline #1. The lithium anode from streamline #2 and streamline #3 are then combined with the PME-cathode from streamline #1 and laminated by laminator 1113. In some embodiments, the lamination is carried out at a scheduled time and at a temperature between about 50° C. to about 130° C. for about 1 minute to about 60 minutes between two lamination plates. Following the lamination step, a battery cell comprising a first layer including the negative current collector 1114, a second layer including a lithium anode 1115, a third layer including the PME layer 1116, a fourth layer including the PME-cathode 1117, a fifth layer including the shared positive current collector 1118, a sixth layer including a PME-cathode 1119, a seventh layer including a PME layer 1120, an eighth layer including a lithium anode 1121, and lastly, a ninth layer including a negative current collector 1222 is formed.

In some embodiments, the width of lithium anode is smaller than the PME layer but larger than the width of the PME-cathode area underneath the PME layer so as to ensure utilization of the entire cathode area. The larger PME layer will prevent shorting of the cell by isolating the positive current collector from the lithium layers.

In alternative embodiments, the process 1100 can include using “bare” current collectors (e.g., current collectors without the lithium metal). In yet another embodiment, the process 1100 does not include using a current collector and, instead, the process includes only the use of lithium metal.

The process 1100 then continues to the assembly of the battery cell. The assembly can include a singulation, functional testing, and/or final packaging steps. The process 1100 can continue to the singulation stage 1127, where the battery cell is cut into different sizes to make different formats of solid-state LiBs. The process 1100 can then continue to the functional testing stage 1128 where the singulated cells are tested for functionality. Functionality tests can include checking the edges of the PME-anode and PME-cathode, DC resistance, no short circuiting, ACI, and OCV. After the functionality of the singulated cells is confirmed, the cells are transferred to the packaging stage 1129 where tabs are welded onto the current collectors and the cells are packaged into a container to complete the full battery assembly.

From the foregoing, it will be appreciated that specific embodiments of the invention have been described herein for purposes of illustration, but that various modifications may be made without deviating from the scope of the invention. Accordingly, the invention is not limited except as by the appended claims.

Para. A. A process of forming a battery cell, the process comprising: (a) feeding a positive current collector to a cathode depositing zone, (b) depositing on to the positive current collector a polymer-matrix electrolyte (PME)-cathode layer comprising at least one salt, at least one polymer, and at least one cathode active material is deposited onto the positive current collector; (c) feeding the PME-cathode layer to a PME depositing zone, (d) depositing onto the PME-cathode layer a PME layer to form a PME overcoated PME-cathode layer; (e) combining the PME overcoated PME-cathode layer with an anode to form a battery cell, and (f) interposing the PME layer between the PME-cathode layer and the anode, wherein the PME-cathode layer, PME layer, or both are in a solvated state throughout the process.

Para. B. The process of Para. A, wherein operations (a)-(d) occur simultaneously.

Para. C. The process of Para. A or B, wherein the PME-cathode layer in a solvated state comprises solvent and/or plasticizer in an amount of at least about 5% to about 20%, by weight, of a total weight of the PME-cathode layer.

Para. D. The process of any one of Paras. A to C, wherein the PME layer in a solvated state comprises solvent in an amount of at least about 5% to about 20%, by weight, of a total weight of the PME layer.

Para. E. The process of any one of Paras. A to D, wherein the anode is a lithium metal anode.

Para. F. The process of Para. E., wherein the lithium metal anode further comprises a negative current collector.

Para. G. The process of any one of Paras. A to D, wherein the anode is a PME-anode layer comprising at least one salt, at least one polymer, and at least one anode active material.

Para. H. The process of any one of Paras. G, wherein the PME-anode layer is in a solvated state comprising solvent in an amount of at least about 5% to about 20%, by weight, of a total weight of the PME-anode layer.

Para. I. The process of Para. H, further comprising: feeding a substrate to an anode depositing zone, depositing the PME-anode layer onto the substrate; feeding a negative current collector on top of the PME-anode, interposing the PME-anode layer between the substrate and the negative current collector anode; detaching the substrate from the PME-anode layer; and combining the PME-cathode layer with the PME-anode layer.

Para. J. The process of any one of Paras. A to I, further comprising laminating the PME-cathode layer to the anode layer.

Para. K. The process of any one of Paras. A to J, wherein an area of the PME layer is about 0.5 mm to about 0.2 mm larger than an area of the PME-cathode layer in any dimension.

Para. L. The process of any one of Paras. A to K, wherein an area of the anode is the same as an area of the PME-cathode and less than an area of the PME layer.

Para. M. The process of any one of Paras. A to L, wherein the salt is a lithium salt and comprises one or more of: LiCl, LiBr, LiI, Li(ClO₄), Li(BF₄), LiPF₆, Li(AsF₆), Li(CH₃CO₂), Li(CF₃SO₃), Li(CF₃SO₂)₂N, Li(CF₃SO₂)₃, Li(CF₃CO₂), Li(B(C₆H₅)₄), Li(SCN), LiB(C₂O₄)₂, Li(NO₃), lithium bis(trifluorosulfonyl)imide (LiTFSI), lithium bis(fluorosulfonyl)imide (LiFSI), lithium difluoro(oxalato)borate (LiDFOB) and lithium bis(oxalato)borate (LiBOB).

Para. N. The process of any one of Paras. A to M, wherein the cathode active material is selected from the group comprising one or more of: lithium nickel cobalt manganese oxide (LiNiCoMnO₂) (NMC), lithium iron phosphate (LiFePO₄), lithium nickel manganese spinel (LiNi_{0.5}Mn_{1.5}O₄) (LNMO), lithium nickel cobalt aluminum oxide (LiNiCoAlO₂) (NCA), lithium manganese oxide (LiMn₂O₄) (LMO), and lithium cobalt oxide (LiCoO₂) (LCO).

Para. O. The process of any one of Paras. A to N, wherein the at least one salt is a lithium salt and comprises one or more of: LiCl, LiBr, LiI, Li(ClO₄), Li(BF₄), LiPF₆, Li(AsF₆), Li(CH₃CO₂), Li(CF₃SO₃), Li(CF₃SO₂)₂N, Li(CF₃SO₂)₃, Li(CF₃CO₂), Li(B(C₆H₅)₄), Li(SCN), LiB(C₂O₄)₂, Li(NO₃), lithium bis(trifluorosulfonyl)imide (LiTFSI) and lithium bis(oxalato)borate (LiBOB).

Para. P. The process of Para. G, wherein the anode active material comprises one or more of: carbonaceous materials; carbonaceous materials doped with silicon or tin; metallic lithium, a lithium alloy or a lithium compound; amorphous tin doped with cobalt or iron/nickel; an oxide selected from the group consisting of: iron oxide, ruthenium oxide, molybdenum oxide, tungsten oxide, titanium oxide and tin oxide; silicon oxides; and silicon nitrides.

Para. Q. The process of Para. G., wherein the anode active material comprises one or more of: non-graphitic carbon, artificial carbon, artificial graphite, natural graphite, pyrolytic carbons and activated carbon.

Para. R. The process of any one of Paras. A to G, wherein the at least one polymer comprises one or more of: a fluorocarbon polymer; a polyacrylonitrile polymer; polyphenylene sulfide (PPS); poly(p-phenylene oxide) (PPE); a liquid crystal polymer (LCP); polyether ether ketone (PEEK); polyphthalamide (PPA); polypyrrole; polyaniline; polysulfone; an acrylate polymer; polyethylene oxide (PEO); polypropylene oxide (PPO); poly(bis(methoxy-ethoxy-ethoxide))-phosphazene (MEEP); polyacrylonitrile (PAN); polymethylmethacrylate (PMMA); polymethyl-acrylonitrile (PMAN); poly(ethylene glycol) diacrylate (PEGDA); a polyimide polymer; co-polymers including monomers of these polymers; and mixtures of these polymers.

Para. S. A process of forming a battery cell, the process comprising: (a) feeding a substrate to a first polymer-matrix electrolyte (PME) electrode depositing zone, (b) depositing a first PME electrode layer onto the substrate, wherein the PME electrode layer is either a PME-anode or PME-cathode layer; (c) feeding a current collector on top of the first PME electrode layer deposited onto the substrate, wherein the current collector is a positive current collector when the PME electrode layer is a PME-cathode or a negative current collector when the PME electrode layer is a PME-anode; (d) feeding the current collector to a second PME electrode depositing zone, (e) depositing a second PME electrode layer onto the current collector, (f) interposing the current collector between the first PME electrode layer and the second PME electrode layer, wherein the second PME electrode layer is the same as the first PME electrode layer; (g) detaching the substrate from the first PME electrode layer; (h) feeding the current collector interposed between the first PME electrode layer and the second PME electrode layer to a third PME depositing zone, (i) depositing a PME layer onto the first PME-electrode layer and the second PME electrode layer to form a first PME layer and a second PME layer; and (j) combining a first electrode layer to the first PME layer and a second electrode layer to the second PME layer to form a battery cell, wherein the first and second electrode layers are an anode when the first and second PME-electrode layers are a PME-cathode or the first and second electrode layers are a cathode when the first and second PME-electrode layers are a PME-anode, and wherein the first and second PME-electrode layers and first and second PME layers remain in a solvated state throughout the process.

Para. T. The process of Para. S, wherein operations (a)-(g) occur simultaneously.

Para. U. The process of Para. S, wherein operations (a)-(h) are repeated at least once to form one or more battery cells.

Para. V. The process of Para. U, further comprising stacking the one or more battery cells to form a multi-layer battery cell.

Para. W. The process of any one of Paras. S to V, wherein operation (g) comprises depositing the second PME layer onto a substrate and combining the second PME layer with the second PME electrode layer.

Para. X. The process of any one of Para. W, further comprising removing the substrate from the second PME layer.

Para. Y. The process of any one of Paras. S to X, wherein the first and second PME-electrode layers in a solvated state comprise solvent in an amount of at least about 5% to about 20%, by weight, of a total weight of the PME-electrode layers.

Para. Z. The process of any one of Paras S to Y, wherein the first and second PME layers in a solvated state comprise solvent in an amount of at least about 5% to about 20%, by weight, of a total weight of the first and second PME layers.

Para. AA. The process of any one of Paras. S to Z, wherein the first and second electrode layer are an anode comprising a lithium metal.

Para. AB. The process of any one of Paras. S to Z, wherein the first and second electrode layers are a PME-anode.

Para. AC. The process of Para. AB, wherein the battery cell comprises, sequentially, a first PME-anode layer, a first PME layer, a first PME-cathode layer, a centrally located common positive current collector, a second PME-cathode layer, a second PME layer, and a second PME-anode layer.

Para. AD. The process of Para. AC, further comprising feeding a first negative current collector on top of the first PME-anode layer and a second negative current collector on top of the second PME-anode layer to form a battery cell sandwiched between the first and second negative current collectors.

Para. AE. The process of any one of Paras. S to Z, wherein the first and second electrode layers are a PME-cathode.

Para. AF. The process of Para. AE, wherein the battery cell layer comprises, sequentially, a first PME-cathode layer, a first PME layer, a first PME-anode layer, a centrally located common negative current collector, a second PME-anode layer, a second PME layer, and a second PME-cathode layer.

Para. AG. The process of Para. AF, further comprising feeding a first positive current collector on top of the first PME-cathode layer and a second positive current collector on top of the second PME-cathode layer to form a battery cell sandwiched between the first and second positive current collectors.

I/we claim:

1. A process of forming a battery cell, the process comprising:
(a) feeding a positive current collector to a cathode depositing zone,
(b) depositing on to the positive current collector a polymer-matrix electrolyte (PME)-cathode layer comprising at least one salt, at least one polymer, and at least one cathode active material is deposited onto the positive current collector;
(c) feeding the PME-cathode layer to a PME depositing zone,
(d) depositing onto the PME-cathode layer a PME layer to form a PME overcoated PME-cathode layer;
(e) combining the PME overcoated PME-cathode layer with an anode to form a battery cell, and
(f) interposing the PME layer between the PME-cathode layer and the anode, wherein the PME-cathode layer, PME layer, or both are in a solvated state throughout the process.

2. The process of claim 1, wherein operations (a)-(d) occur simultaneously.

3. The process of claim 1, wherein the PME-cathode layer in a solvated state comprises solvent and/or plasticizer in an amount of at least about 5% to about 20%, by weight, of a total weight of the PME-cathode layer.

4. The process of claim 1, wherein the PME layer in a solvated state comprises solvent in an amount of at least about 5% to about 20%, by weight, of a total weight of the PME layer.

5. The process of claim 1, wherein the anode is a lithium metal anode.

6. The process of claim 1, wherein the lithium metal anode further comprises a negative current collector.

7. The process of claim 1, wherein the anode is a PME-anode layer comprising at least one salt, at least one polymer, and at least one anode active material.

8. The process of claim 7, wherein the PME-anode layer is in a solvated state comprising solvent in an amount of at least about 5% to about 20%, by weight, of a total weight of the PME-anode layer.

9. The process of claim 8, further comprising:
feeding a substrate to an anode depositing zone,
depositing the PME-anode layer onto the substrate;
feeding a negative current collector on top of the PME-anode,
interposing the PME-anode layer between the substrate and the negative current collector anode;
detaching the substrate from the PME-anode layer; and
combining the PME-cathode layer with the PME-anode layer.

10. The process of claim 1, further comprising laminating the PME-cathode layer to the anode layer.

11. The process of claim 1, wherein an area of the PME layer is about 0.5 mm to about 0.2 mm larger than an area of the PME-cathode layer in any dimension.

12. The process of claim 1, wherein an area of the anode is the same as an area of the PME-cathode and less than an area of the PME layer.

13. The process of claim 1, wherein the salt is a lithium salt and comprises one or more of: LiCl, LiBr, LiI, Li(ClO₄), Li(BF₄), LiPF₆, Li(AsF₆), Li(CH₃CO₂), Li(CF₃SO₃), Li(CF₃SO₂)₂N, Li(CF₃SO₂)₃, Li(CF₃CO₂), Li(B(C₆H₅)₄), Li(SCN), LiB(C₂O₄)₂, Li(NO₃), lithium bis(trifluorosulfonyl)imide (LiTFSI), lithium bis(fluorosulfonyl)imide (LiFSI), lithium difluoro(oxalato)borate (LiDFOB) and lithium bis(oxalato)borate (LiBOB).

14. The process of claim 1, wherein the cathode active material is selected from the group comprising one or more of: lithium nickel cobalt manganese oxide (LiNiCoMnO₂) (NMC), lithium iron phosphate (LiFePO₄), lithium nickel manganese spinel (LiNi_{0.5}Mn_{1.5}O₄) (LNMO), lithium nickel cobalt aluminum oxide (LiNiCoAlO₂) (NCA), lithium manganese oxide (LiMn₂O₄) (LMO), and lithium cobalt oxide (LiCoO₂) (LCO).

15. The process of claim 7, wherein the at least one salt is a lithium salt and comprises one or more of: LiCl, LiBr, LiI, Li(ClO₄), Li(BF₄), LiPF₆, Li(AsF₆), Li(CH₃CO₂), Li(CF₃SO₃), Li(CF₃SO₂)₂N, Li(CF₃SO₂)₃, Li(CF₃CO₂), Li(B(C₆H₅)₄), Li(SCN), LiB(C₂O₄)₂, Li(NO₃), lithium bis(trifluorosulfonyl)imide (LiTFSI) and lithium bis(oxalato)borate (LiBOB).

16. The process of claim 7, wherein the anode active material comprises one or more of:
carbonaceous materials;
carbonaceous materials doped with silicon or tin;
metallic lithium, a lithium alloy or a lithium compound;
amorphous tin doped with cobalt or iron/nickel;
an oxide selected from the group consisting of: iron oxide, ruthenium oxide, molybdenum oxide, tungsten oxide, titanium oxide and tin oxide;
silicon oxides; and
silicon nitrides.

17. The process of claim 7, wherein the anode active material comprises one or more of: non-graphitic carbon, artificial carbon, artificial graphite, natural graphite, pyrolytic carbons and activated carbon.

18. The process of claim 1, wherein at least one polymer comprises one or more of: a fluorocarbon polymer; a polyacrylonitrile polymer; polyphenylene sulfide (PPS); poly(p-phenylene oxide) (PPE); a liquid crystal polymer (LCP); polyether ether ketone (PEEK); polyphthalamide (PPA); polypyrrole; polyaniline; polysulfone; an acrylate polymer; polyethylene oxide (PEO); polypropylene oxide (PPO); poly(bis(methoxy-ethoxy-ethoxide))-phosphazene (MEEP); polyacrylonitrile (PAN); polymethylmethacrylate (PMMA); polymethyl-acrylonitrile (PMAN); poly(ethylene glycol) diacrylate (PEGDA); a polyimide polymer; co-polymers including monomers of these polymers; and mixtures of these polymers.

19. A process of forming a battery cell, the process comprising:
(a) feeding a substrate to a first polymer-matrix electrolyte (PME) electrode depositing zone,
(b) depositing a first PME electrode layer onto the substrate, wherein the PME electrode layer is either a PME-anode or PME-cathode layer;
(c) feeding a current collector on top of the first PME electrode layer deposited onto the substrate, wherein the current collector is a positive current collector when the PME electrode layer is a PME-cathode or a negative current collector when the PME electrode layer is a PME-anode;
(d) feeding the current collector to a second PME electrode depositing zone,
(e) depositing a second PME electrode layer onto the current collector,
(f) interposing the current collector between the first PME electrode layer and the second PME electrode layer, wherein the second PME electrode layer is the same as the first PME electrode layer;
(g) detaching the substrate from the first PME electrode layer;
(h) feeding the current collector interposed between the first PME electrode layer and the second PME electrode layer to a third PME depositing zone,
(i) depositing a PME layer onto the first PME-electrode layer and the second PME electrode layer to form a first PME layer and a second PME layer; and
(j) combining a first electrode layer to the first PME layer and a second electrode layer to the second PME layer to form a battery cell, wherein the first and second electrode layers are an anode when the first and second PME-electrode layers are a PME-cathode or the first and second electrode layers are a cathode when the first and second PME-electrode layers are a PME-anode, and wherein the first and second PME-electrode layers and first and second PME layers remain in a solvated state throughout the process.

20. The process of claim 19, wherein operations (a)-(g) occur simultaneously.

21. The process of claim 20, wherein operations (a)-(h) are repeated at least once to form one or more battery cells.

22. The process of claim 21, further comprising stacking the one or more battery cells to form a multi-layer battery cell.

23. The process of claim 19, wherein operation (g) comprises depositing the second PME layer onto a substrate and combining the second PME layer with the second PME electrode layer.

24. The process of claim 23, further comprising removing the substrate from the second PME layer.

25. The process of claim 19, wherein the first and second PME-electrode layers in a solvated state comprise solvent in an amount of at least about 5% to about 20%, by weight, of a total weight of the PME-electrode layers.

26. The process of claim 19, wherein the first and second PME layers in a solvated state comprise solvent in an amount of at least about 5% to about 20%, by weight, of a total weight of the first and second PME layers.

27. The process of claim 19, wherein the first and second electrode layer are an anode comprising a lithium metal.

28. The process of claim 19, wherein the first and second electrode layers are a PME-anode.

29. The process of claim 28, wherein the battery cell comprises, sequentially, a first PME-anode layer, a first PME layer, a first PME-cathode layer, a centrally located common positive current collector, a second PME-cathode layer, a second PME layer, and a second PME-anode layer.

30. The process of claim 29, further comprising feeding a first negative current collector on top of the first PME-anode layer and a second negative current collector on top of the second PME-anode layer to form a battery cell sandwiched between the first and second negative current collectors.

31. The process of claim 19, wherein the first and second electrode layers are a PME-cathode.

32. The process of claim 31, wherein the battery cell layer comprises, sequentially, a first PME-cathode layer, a first PME layer, a first PME-anode layer, a centrally located common negative current collector, a second PME-anode layer, a second PME layer, and a second PME-cathode layer.

33. The process of claim 32, further comprising feeding a first positive current collector on top of the first PME-cathode layer and a second positive current collector on top of the second PME-cathode layer to form a battery cell sandwiched between the first and second positive current collectors.
